(19) United States
(12) Patent Application Publication
(10) Pub. No.: US 2013/0224718 A1
(43) Pub. Date: Aug. 29, 2013

(54) METHODS AND SYSTEMS FOR PROVIDING INFORMATION CONTENT TO USERS

(71) Applicant: Psygon, Inc., (US)

(72) Inventor: Dean T. Woodward, Chapel Hill, NC (US)

(73) Assignee: PSYGON, INC., Chapel Hill, NC (US)

(21) Appl. No.: 13/775,578

(22) Filed: Feb. 25, 2013

Related U.S. Application Data
(60) Provisional application No. 61/603,394, filed on Feb. 27, 2012.

(51) Int. Cl. G09B 7/00

(52) U.S. Cl. CPC G09B 7/00
USPC 434/350; 434/362

(57) ABSTRACT

Methods and system for organizing and providing informational content to users are disclosed. According to an aspect, a method may be implemented by a processor and include receiving user response to presentation of informational content associated with a first difficulty level. The method may also include associating a second difficulty level with the informational content based at least partly on the user response and the first difficulty level. Further, the method may include providing the informational content to a user based at least partly on the second difficulty level.

### CROSS REFERENCE TO RELATED APPLICATION

This application claims the benefit of U.S. Provisional Patent Application Ser. No. 61/603,394, filed Feb. 27, 2012, the disclosure of which is incorporated herein by reference in its entirety.

### TECHNICAL FIELD

The presently disclosed subject matter relates to computing devices and systems, and more specifically, to computing devices and systems for providing informational content to users.

### BACKGROUND

Computers are often used as teaching tools for presenting educational content or other informational content to users. For example, a computer may present a series of questions to a user and receive answers from the user. The computer may then indicate whether the user correctly answered the questions and, if not, present correct answers to the user. Such computers are useful in testing users at a particular proficiency but are limited in assisting a user to improve their proficiency or understanding of a subject.

Adaptive learning is an educational technique implemented by computers that provides interactive teaching. In this technique, computers adapt the presentation of educational content to a user based on his or her responses to the questions. For example, different questions may be presented to a user based at least partly on his or her responses to previous questions.

Current computer teaching tools are limited in that questions are not validated by any objective, measurable criteria to assist in determining the difficulty or relevance of such questions. As a result, a user has very little information available to determine the usefulness of such a question relative to his or her understanding of the content or material being studied. Further, the user has few, if any, opportunities to measure their current proficiency level relative to others or relative to a defined standard. For at least these reasons, it is desired to provide improved computer teaching tools and, more generally, to provide improved computer tools for providing informational content to users.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Disclosed herein are methods and a system for providing informational content to users. According to an aspect, a method may be implemented by a processor and include receiving user response to presentation of informational content associated with a first difficulty level. The method may also include associating a second difficulty level with the informational content based at least partly on the user response and the first difficulty level. Further, the method may include providing the informational content to a user based on the second difficulty level.

According to another aspect, a method may include presenting informational content associated with a difficulty level. The method may also include receiving user response, from a user, to the presentation of the informational content. Further, the method may include associating a proficiency level with the user based at least partly on the user response and the difficulty level.

According to another aspect, a method may include receiving user responses to presentation of informational content from a plurality of different users over a period of time. Further, the method may include associating different difficulty levels with the informational content over the period of time and based at least partly on the user responses.

### BRIEF DESCRIPTION OF THE DRAWINGS

The foregoing summary, as well as the following detailed description of various embodiments, is better understood when read in conjunction with the appended drawings. For the purposes of illustration, there is shown in the drawings exemplary embodiments; however, the presently disclosed subject matter is not limited to the specific methods and instrumentalities disclosed. In the drawings:

FIG. 1 is a schematic diagram of an example computing system for providing informational content to users in accordance with embodiments of the present subject matter;

FIG. 2 is a flowchart of an example method for providing informational content to a user in accordance with embodiments of the present disclosure;

FIG. 3 is a flowchart of an example method for associating a proficiency level with a user in accordance with embodiments of the present disclosure;

FIG. 4 is a flowchart of an example method for associating difficulty levels with informational content in accordance with embodiments of the present disclosure;

FIG. 5 is a screen display showing an example question screen in accordance with embodiments of the present disclosure;

FIG. 6 is a screen display showing an example answer screen in which the user has responded to the question of FIG. 5 in accordance with embodiments of the present disclosure;

FIG. 7 is a screen display of an example user profile in accordance with embodiments of the present disclosure;

FIG. 8 is a screen display of an example question profile in accordance with embodiments of the present disclosure;

FIG. 9 is a screen display of an example leaderboard in accordance with embodiments of the present disclosure;

FIG. 10 is a screen display of an example category leaderboard in accordance with embodiments of the present disclosure;

FIG. 11 is a screen display of another example in which a user may input an answer to a question in accordance with embodiments of the present disclosure;

FIG. 12 is a screen display of another example in which awards and user statistics for a user are displayed in accordance with embodiments of the present disclosure;

FIG. 13 is a screen display of another example in which a question is presented to and answered by a user in accordance with embodiments of the present disclosure;

FIG. 14 is a screen display of another example in which a question is presented to and answered by a user in accordance with embodiments of the present disclosure;

FIG. 15 is a screen display of another example in which the correct answer to a question and its explanation is presented to a user in accordance with embodiments of the present disclosure;

FIG. 16 is a screen display of another example in which information about questions authored by a user is presented in accordance with embodiments of the present disclosure;

FIG. 17 is a screen display of another example in which information about a user's review list is presented to a user in accordance with embodiments of the present disclosure;

FIG. 18 is a screen display of another example in which a question, a user's incorrect answer, and an indication of the correct answer is presented to a user in accordance with embodiments of the present disclosure;

FIG. 19 is a screen display of another example in which a question is presented to a user in accordance with embodiments of the present disclosure; and

FIG. 20 is a screen display of an example in which a reading passage is presented to a user in accordance with embodiments of the present disclosure.

### DETAILED DESCRIPTION

The presently disclosed subject matter is described with specificity to meet statutory requirements. However, the description itself is not intended to limit the scope of this patent. Rather, the inventor has contemplated that the claimed subject matter might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described. Further, the term ‘based on’ as used herein, is to be broadly construed, to include the concepts of partly or partially based upon one or more factors, elements or steps, as well as predominantly or even exclusively based upon one or more factors, elements or steps.

In accordance with embodiments of the presently disclosed subject matter, methods, computing devices, and computing systems are disclosed herein for providing informational content to users. In an embodiment, a computing system may receive user response to presentation of informational content associated with a predefined difficulty level. For example, a computer may receive answers from a user to a series of questions presented by the computer, or may receive feedback from a user that informational content is above the user's comprehension level, below the user's comprehension level, or appropriate for the user. In this example, the questions or informational content may be assigned or otherwise associated with a particular difficulty score. The computing system may also associate another difficulty level with the informational content based on the user response and the predefined difficulty level. For example, a computer may assign or otherwise associate a different difficulty level with the informational content based on the previous difficulty level associated with the content and/or answers or other feedback received from the user. The computing system may provide the informational content to another user based on the newly associated difficulty level. For example, the informational content may be presented to another user having a proficiency level that is suited to the newly associated difficulty level. In this way, for example, responses provided by one user may be used to better match the informational content to another user.

The presently disclosed subject matter may be used to validate informational content, such as questions, by objective, measurable criteria for assisting in determining the difficulty and/or relevance of such questions. Therefore, a user is provided with information for determining the usefulness of the informational content to their understanding of a subject or material being studied. In addition, a user is provided with a way to measure his or her current level of understanding relative to others or relative to a defined standard. The presently disclosed subject matter may also be used to assist users when seeking help from experts in a particular subject by providing, for example, information about the proficiency of the expert. A user may be presented with an indicator of the proficiency of other users, including but not limited to experts, in one or more subjects.

As referred to herein, the term “computing device” should be broadly construed. It can include any type of device capable of providing electronic or digital informational content to a user or other functionality as described herein. For example, the computing device may be a smart phone or a computer configured to display or otherwise present questions or other informational content to a user. The computing device may also be configured to receive answers to the questions, or other user response with respect to other types of informational content. For example, a computing device may be a mobile device such as, for example, but not limited to, a smart phone, a cell phone, a pager, a personal digital assistant (PDA, e.g., with GPRS NIC), a mobile computer with a smart phone client, or the like. A computing device can also include any type of conventional computer, for example, a desktop computer or a laptop computer. A typical mobile computing device is a wireless data access-enabled device (e.g., an iPHONE® smart phone, a BLACKBERRY® smart phone, a NEXUS ONE™ smart phone, an iPAD® device, or the like) that is capable of sending and receiving data in a wireless manner using protocols like the Internet Protocol, or IP, and the wireless application protocol, or WAP. This allows users to access information via wireless devices, such as smart phones, mobile phones, pagers, two-way radios, communicators, and the like. Wireless data access is supported by many wireless networks, including, but not limited to, CDPD, CDMA, GSM, PDC, PHS, TDMA, FLEX, ReFLEX, iDEN, TETRA, DECT, DataTAC, Mobitex, EDGE, WiMAX and other 2G, 3G, 4G and LTE technologies, and it operates with many handheld device operating systems, such as PalmOS, EPOC, Windows CE, FLEXOS, OS/9, JavaOS, iOS and Android. Typically, these devices use graphical displays and can access the Internet (or other communications network) on so-called mini- or micro-browsers, which are web browsers with small file sizes that can accommodate the reduced memory constraints of wireless networks. In a representative embodiment, the mobile device is a cellular telephone or smart phone that operates over GPRS (General Packet Radio Services), which is a data technology for GSM networks. In addition to a conventional voice communication, a given mobile device can communicate with another such device via many different types of message transfer techniques, including SMS (short message service), enhanced SMS (EMS), multi-media message (MMS), email WAP, paging, or other known or later-developed wireless data formats.

As referred to herein, a “user interface” (UI) is generally a system by which users interact with a computing device. An interface can include an input for allowing users to manipulate a computing device, and can include an output for allowing the system to present information (e.g., e-book content) and/or data, indicate the effects of the user's manipulation, etc. An example of an interface on a computing device includes a graphical user interface (GUI) that allows users to interact with programs in more ways than typing. A GUI typically can offer display objects, and visual indicators, as opposed to text-based interfaces, typed command labels or text navigation to represent information and actions available to a user. For example, an interface can be a display window or display object, which is selectable by a user of a computing device for interaction. The display object can be displayed on a display screen of a computing device and can be selected by and interacted with by a user using the interface. In an example, the display of the computing device can be a touch screen, which can display the display icon. The user can depress the area of the display screen at which the display icon is displayed for selecting the display icon. In another example, the user can use any other suitable interface of a computing device, such as a keypad, to select the display icon or display object. For example, the user can use a track ball or arrow keys for moving a cursor to highlight and select the display object.

Operating environments in which embodiments of the present disclosure may be implemented are also well-known. In an embodiment, a computing device may be connected with the Internet or another network such that the computing device may communicate with other computing devices in accordance with the presently disclosed subject matter. In another embodiment, a mobile computing device is connectable (for example, via WAP) to a transmission functionality that varies depending on implementation. Thus, for example, where the operating environment is a wide area wireless network (e.g., a 2.5G network, a 3G network, a 4G network, or a WiMAX network), the transmission functionality comprises one or more components such as a mobile switching center (MSC) (an enhanced ISDN switch that is responsible for call handling of mobile subscribers), a visitor location register (VLR) (an intelligent database that stores on a temporary basis data required to handle calls set up or received by mobile devices registered with the VLR), a home location register (HLR) (an intelligent database responsible for management of each subscriber's records), one or more base stations (which provide radio coverage with a cell), a base station controller (BSC) (a switch that acts as a local concentrator of traffic and provides local switching to effect handover between base stations), and a packet control unit (PCU) (a device that separates data traffic coming from a mobile device). The HLR also controls certain services associated with incoming calls. Of course, embodiments in accordance with the present disclosure may be implemented in other and next-generation mobile networks and devices as well. The computing device is the physical equipment used by the end user, typically a subscriber to the wireless network. Typically, a mobile device is a 2.5G-compliant device, 3G-compliant device, or 4G-compliant device that includes a subscriber identity module (SIM), which is a smart card that carries subscriber-specific information, mobile equipment (e.g., radio and associated signal processing devices), a user interface (or a man-machine interface (MMI)), and one or more interfaces to external devices (e.g., computers, PDAs, and the like). The computing device may also include one or more processors and memory for implementing functionality in accordance with embodiments of the presently disclosed subject matter.

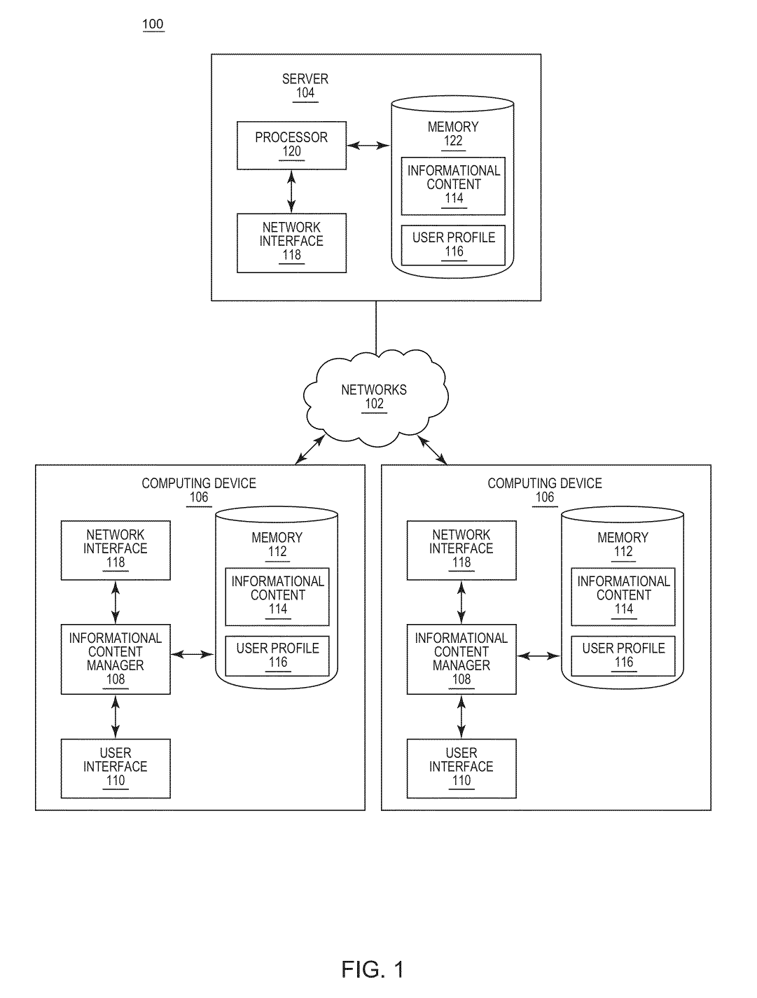

The presently disclosed subject matter is now described in more detail. For example, FIG. 1 illustrates a schematic diagram of an example computing system 100 for providing informational content to users in accordance with embodiments of the present subject matter. Referring to FIG. 1, the system 100 includes one or more networks 102, a server 104, and multiple computing devices 106. The server 104 and computing devices 106 may be any type of computing devices capable of providing informational content to a user or performing any other functions in accordance with the presently disclosed subject matter. This representation of the server 104 and computing devices 106 is meant to be for convenience of illustration and description, and it should not be taken to limit the scope of the present disclosure as one or more functions may be combined. Typically, these components are implemented in software (as a set of process-executed computer instructions, associated data structures, and the like). One or more of the functions may be combined or otherwise implemented in any suitable manner (e.g., in hardware, in combined hardware and software, and the like). The computing devices 106 may each include an informational content manager 108 for implementing functions disclosed herein. The computing devices 106 may each include a user interface 110 capable of receiving user input and of presenting informational content to a user. For example, the user interface 110 may include a display capable of displaying questions and answers to a user. The computing devices 106 may each include a memory 112 configured to store informational content and its associated data 114 and user profile information 116 as disclosed herein.

The computing devices 106 may also be capable of communicating with each other, the server 104, and other devices. For example, the computing devices 106 may each include a network interface 118 capable of communicating with the server 104 via the network(s) 102. The network(s) 102 may include the Internet, a wireless network, a local area network (LAN), or any other suitable network. In another example, the computing devices 106 can be Internet-accessible and can interact with the server 104 using Internet protocols such as HTTP, HTTPS, and the like.

The operation of one of the computing devices 106 can be described by the following example. As shown in FIG. 1, a computing device 106 includes various functional components and the memory 112 to facilitate the operation. The operation of the disclosed methods may be implemented using components other than as shown in FIG. 1. In an alternative embodiment, this example operation may be suitably implemented by any other suitable computing device, such as, but not limited to, a computer or other computing device having at least a processor and a memory.

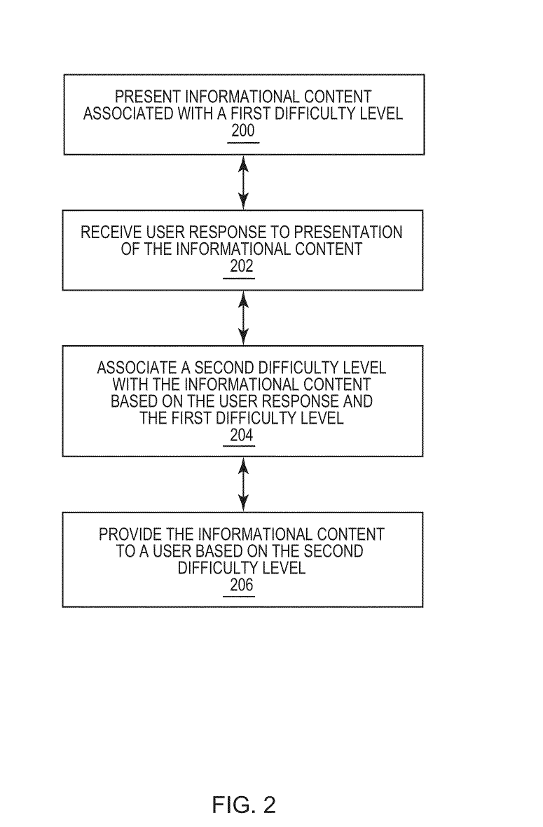

In an example, a user of the computing device 106 may use an application residing on the computing device 106 to present informational content to a user and implement other functions disclosed herein. The application may be implemented by the informational content manager 108. For example, FIG. 2 illustrates a flowchart of an example method for providing informational content to a user in accordance with embodiments of the present disclosure. For purposes of illustration, the method of FIG. 2 is described as being implemented by one of the computing devices 106, but the method may be implemented by any other suitable computing device. The various components of the system 100 shown in FIG. 1 may execute the steps of the method of FIG. 2, and may be implemented by software, hardware, firmware, or combinations thereof.

Referring to FIG. 2, the method includes presenting informational content associated with a first difficulty level (step 200). For example, the informational content manager 108 of one of the computing devices 106 shown in FIG. 1 may retrieve one or more items of informational content, such as, for example, questions, within the informational content 114 stored in the memory 112. Subsequently, the informational content manager 108 may control the user interface 110 to present the question(s) to the user. For example, a display of the user interface 110 may display the questions sequentially and provide a user with time to input a response (e.g., answers) to the questions. The questions may be assigned or otherwise associated with a particularly difficulty level. For example, the questions may be assigned a difficulty score, which can be a numeric value representative of the difficulty of the questions in a particular subject area.

The method of FIG. 2 includes receiving user response to presentation of the informational content (step 202). For example, the user may input one or more answers to questions presented by computing device 106. For informational content not comprising questions, the user may input information that indicates that the informational content is, for example, above the user's level of understanding, below the user's level of understanding, or appropriate for the user's level of understanding. The user may also input other information, such as an indication of the relevance of the informational content to a subject being tested or taught. The user may interact with the user interface 110 for inputting the response.

The method of FIG. 2 includes associating a second difficulty level with the informational content based in part on the user response and the first difficulty level (step 204). For example, the computing device 106 may communicate the user responses to the server 104. A processor 120 and memory 122 of the server 104 may determine another difficulty level for the informational content based at least partly on the received user response information and the first difficulty level. For example, if the user incorrectly answered a question, the difficulty level of the question may be changed to a higher difficulty level. In contrast, if the user correctly answered a question, the difficulty level of the question may be changed to a lower difficulty level. In another embodiment, if a user responded to informational content in a way that indicated that the informational content was at a difficulty level higher than the level appropriate for the user, the difficulty level of the informational content may be changed to a higher difficulty level. On the other hand, if a user responded to informational content in a way that indicated that the informational content was at a difficulty level lower than the level appropriate for the user, the difficulty level of the informational content may be changed to a lower difficulty level. As a result, the difficulty level of the informational content may be changed based at least in part on a response of the user to presentation of the informational content. In some examples, the difficulty level of the informational content may not be changed.

The method of FIG. 2 includes providing the informational content to a user based on the second difficulty level (step 206). For example, the informational content may be provided to another computing device 106 for presentation to another user. The other user may be associated with a particular proficiency level or level of understanding that is suited to the second difficulty level. The server 104 may use its network interface 118 to communicate the informational content to the other computing device 106 via the network(s) 102. The server 104 may store user profile information 116 in its memory 122 for use in matching informational content of a particular difficulty level to a user having a particular proficiency level. If the user and informational content match in this way, the informational content may be provided to the user's computing device.

In an embodiment, user response to presentation of informational content may be received from multiple users. For example, users at multiple computing devices, such as the computing devices 106 shown in FIG. 1, may be presented with the same question or questions. These questions may have been provided to the computing devices from a server, such as the server 104 shown in FIG. 1. The users may interact with respective user interfaces of the computing devices to input their respective answers to the one or more questions. The computing devices may subsequently communicate the user responses to the server where the server may associate a difficulty level with the informational content based partly on the user responses. The difficulty level may be determined based at least partly on a previous difficulty level associated with the informational content or it may be the original difficulty level associated with the informational content. The user responses from the computing devices may be collected over a period of time, and various different difficulty levels may be associated with the informational content as the responses are received at the server. As questions are answered by additional users, the difficulty level for individual questions may be increased or decreased multiple times and may be assigned a numerical value in a range such as 0 to 100, 0 to 1000, or any other suitable range for differentiating informational content according to difficulty.

In another embodiment, a user may input an indication of relevance of informational content in response to presentation of the informational content. The informational content manager 108 may associate a relevance level with the informational content based at least partly on the indication of relevance. For example, for each question presented to the user, the user may input an indication of the relevance of the question to the subject matter being tested or taught to the user. In an example, the user may input an indication that the informational content is relevant, not relevant, or indicate the relevancy on a scale (e.g., a scale of 1 to 10, or a scale of −3 to +3). The informational content manager 108 may control the network interface 118 to communicate the indication of relevance of one or more questions to the server 104 via the network(s) 102. The server 104 may determine a relevance level for the one or more questions based at least partly on the indication of relevance. Subsequently, the server may associate the relevance level with the one or more questions. As a result, the relevance of the questions to a category or subject may be known based on the associated relevance level.

In another embodiment, informational content may be presented or otherwise provided to a user based on its associated relevance level. For example, the user may request questions or informational content related to a particular category or subject. Questions or other informational content associated with a high relevance level for the category or subject may be presented to the user. In an example, a relevance level may be indicated numerically, such as by a relevance score. The user indications of relevance may be collected over a period of time, and the relevance scores may be associated with the informational content as the responses are received at the server. As questions or content are ranked or rated for relevance by additional users, the relevance scores for individual questions may be increased or decreased multiple times.

There are several types of informational content other than questions that can be associated with difficulty and/or relevance as described herein. Such informational content may be reading passages associated with the category that is selected by the user, for which the user may supply a difficulty ranking and/or a relevance ranking for such reading passages. Alternatively, informational content may comprise survey inquiries, where the user may be asked to provide their opinion on one or more matters of interest to the public or the author of such survey inquiries. Such opinions could include statements of preference, such as for products, services, advertisements, offers, political matters or candidates, and other matters of public or private interest. Such opinions may be gathered in several different manners, such as ‘yes or no’, ‘for or against’, rank ordering, proportional voting, semiproportional voting, ranked voting and other methods of expressing or gathering opinion or input that are known in the art. Informational content could also include petitions associated with political matters, votes or opinions collected by, among or between members of associations or affiliated groups, focus group marketing, customer feedback and similar matters of interest to users, authors and sponsors.

In yet another embodiment, a proficiency level may be associated with a user. The proficiency level may be changed based at least partly on user response to informational content. For example, in response to the user correctly answering questions, a proficiency level of the user may increase. In contrast, in response to the user incorrectly answering questions, a proficiency level of the user may decrease. The proficiency level may be indicated numerically. The proficiency level adjustment may be made based on a previous proficiency level of the user. The proficiency level of one or more users may be stored in the user profile 116 of the server 104. A computing device, such as the computing device 106, may store a proficiency level of a user in a user profile 116. Different informational content may be presented to a user based at least partly on the user's proficiency level. For example, if the user's proficiency level is high, informational content of a high difficulty level may be presented to the user. In contrast, if the user's proficiency level is low, informational content of a low difficulty level may be presented to the user.

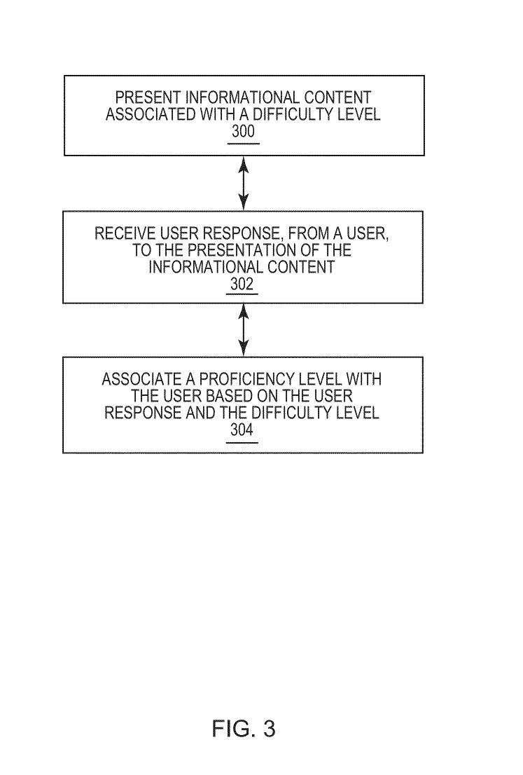

FIG. 3 illustrates a flowchart of an example method for associating a proficiency level with a user in accordance with embodiments of the present disclosure. For purposes of illustration, the method of FIG. 3 is described as being implemented by one of the computing devices 106, but the method may be implemented by any other suitable computing device. The various components of the system 100 shown in FIG. 1 may execute the steps of the method of FIG. 3, and may be implemented by software, hardware, firmware, or combinations thereof.

Referring to FIG. 3, the method includes presenting informational content associated with a difficulty level (step 300). For example, the informational content manager 108 of one of the computing devices 106 shown in FIG. 1 may control a display of the user interface 110 to display questions that are associated with a particular difficulty level. The server 104 may communicate the questions and an indication of the difficulty level to the computing device 106 for presentation to the user. The difficulty level may have been matched to the user based on a proficiency level associated with the user.

The method of FIG. 3 includes receiving user response, from a user, to the presentation of the informational content (step 302). For example, the user may use the user interface 110 (e.g., a keyboard, mouse, touchscreen display, and the like) to input one or more answers to displayed questions. The user response may be communicated to the server 104 via the network(s) 102.

The method of FIG. 3 includes associating a proficiency level with the user based on the user response and the difficulty level (step 304). As an example, if the difficulty of presented questions is high and the user correctly answers many or all of a set of questions, a proficiency level of the user may increase. If the difficulty of presented questions is low and the user incorrectly answers many or all of a set of questions, a proficiency level of the user may decrease. In another example, a single question answered correctly may increase the proficiency level of a user, or a single question answered incorrectly may decrease the proficiency level of a user.

In an embodiment, an adjustment of a proficiency level of a user may also be determined based on a previous proficiency level of the user. For example, if a proficiency level of a user is at a particular level, the current proficiency level may not deviate significantly if the user incorrectly answers a few questions or a small set of questions. Although, if many questions or sets of questions are incorrectly answered, the proficiency level of the user may change significantly.

In another embodiment, a user's proficiency level may be adjusted based at least partly on a plurality of other user response to presentation of informational content. For example, if many other users provided mostly incorrect answers to an individual question or a set of questions, a proficiency level of another user incorrectly answering the questions may not be significantly reduced because the questions may be deemed very difficult. In another example, if many other users provided mostly correct answers to an individual question or a set of questions, a proficiency level of another user incorrectly answering many of the questions may be reduced more significantly because the questions may be deemed easy. The proficiency level of the user may be adjusted in this way even if answers are provided by other users subsequent to the user providing answers.

In another embodiment, a proficiency level of a user may be adjusted based on a relevance level of informational content provided to the user. For example, if questions are presented that are not relevant to a user, a proficiency level of the user may not be adjusted significantly whether the user provides many or all correct or incorrect answers. In contrast, if questions are presented that are relevant to a user, a proficiency level of the user may be adjusted significantly if the user provides many or all correct or incorrect answers.

In yet another embodiment, a proficiency level of a user may be presented to the user. For example, a numerical score representing a proficiency level of a user may be displayed to the user. In another example, the informational content manager 108 may control a display of the user interface 110 to display the proficiency level.

In another example, a proficiency level of a user may be presented to one or more other users via a network, such as the network(s) 102. For example, the server 104 may store the proficiency level and an identifier (e.g., a name) of a user. The server 104 may present the proficiency level to a computing device of the other users via a website, for example. In another example, a proficiency ranking of the user in comparison to other users may be presented. For example, multiple users may be ranked in a category or subject based on their proficiency level for the category or subject, and such rankings and proficiency levels may be displayed or presented to other users, based on privacy, display or other settings of the users' accounts, where such settings may be adjusted by the individual users, or adjusted by the disclosed system.

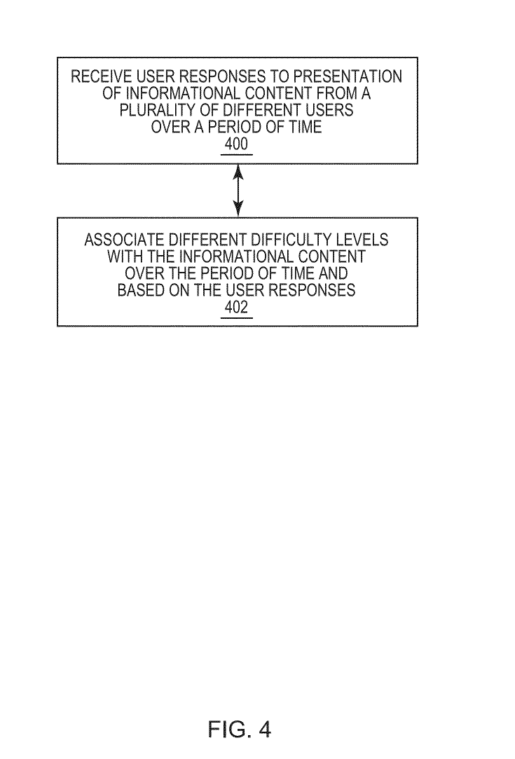

FIG. 4 illustrates a flowchart of an example method for assessing difficulty of informational content in accordance with embodiments of the present disclosure. For purposes of illustration, the method of FIG. 4 is described as being implemented by one of the computing devices 106, but the method may be implemented by any other suitable computing device. The various components of the system 100 shown in FIG. 1 may execute the steps of the method of FIG. 4, and may be implemented by software, hardware, firmware, or combinations thereof.

Referring to FIG. 4, the method includes receiving user responses to presentation of informational content from a plurality of different users over a period of time (step 400). For example, users of the computing devices 106 shown in FIG. 1 and/or other computing devices not shown in FIG. 1 may receive user responses to presentation of questions over a period of time. The informational content manager 108 may control the network interface 118 to communicate the responses to the server 104.

The method of FIG. 4 includes associating different difficulty levels with the informational content over the period of time and based on the user responses (step 402). For example, the difficulty level of the informational content may vary over time based on user responses. For example, the informational content may initially be associated with a particular difficulty level. As additional user responses are received by the server 104, the difficulty level may increase or decrease over time. As a result, a difficulty level associated with the informational content should become more accurate over time because additional data are received.

In an embodiment, the server 104 may be a web server configured to store multiple questions or sets of questions and corresponding answers within informational content 114. A particular difficulty level may be assigned to each question or set of questions. Further, each set and/or each question may be assigned one or more category identifiers and a relevance level for each category identifier. Each category identifier may be a name or other identifier for indicating the set or question's category or subject. Each computing device 106 may be capable of accessing the Internet for logging onto a webpage presented and controlled by the server 104. Subsequent to logging onto or otherwise accessing the webpage, a user may interact with his or her computing device 106 to select a category containing one or more questions. The server 104 may subsequently present the questions of the selected category on a webpage that is displayed on the computing device. The user may also interact with the computing device 106 to input answers to the questions. After answering each question, the user's proficiency level or score increases, decreases, or remains the same according to embodiments of the present disclosure. Further, after each question is answered by a user, the question's difficulty level or rank increases, decreases, or remains the same according to embodiments of the present disclosure. For example, the level or rank of both the user and the answered question may change based on whether the user answers the question correctly or incorrectly.

In an example, a correct answer may be presented via the website after the user submits an answer. The user may then rank the question for relevance. Since each question may be ranked for relevance and difficulty, and the user may see only the most relevant question at their current difficulty level, the server 104 may automatically customize content for each individual. Rankings of individual questions and sets of questions may be performed in real-time by multiple users based on responses of the users to the questions.

It is noted that informational content may be content other than questions. A user may rank any type of informational content as being highly difficult or not difficult, for example, or at an appropriate difficulty level for the user to readily understand and use such information. Similarly, a user may rank any type of informational content as being highly relevant or not relevant to the category or subject being studied.

In accordance with embodiments of the present disclosure, informational content may be identified by relevance and difficulty. For example, the server 104 may present a webpage to a user at a computing device 106 that indicates various informational content and sets of questions and answers along with a relevance level of each set to a particular category or subject. In another example, the server 104 may present a webpage to a user at a computing device 106 that indicates a single question comprising a difficulty level and a relevance level matched to the user by the system based at least partly on the user's most recent proficiency level. After the user answers the question, the system in this example may present the user with a webpage containing the answer to the question, along with or followed by a “Next Question” button or similar webpage item by which the user can obtain an additional question or item of informational content. The system may adjust the proficiency level of the user based upon whether the user's response was correct or incorrect. Upon selecting the option for an additional question in this example, the user may be presented with another webpage by the server 104 that indicates a question comprising a difficulty level and a relevance level matched to the user by the system based at least partly on the user's newly-adjusted proficiency level. By repeating these steps multiple times, the user may encounter a unique series of questions or items of informational content, each of which is presented to the user based at least partly upon the user's individual responses to the previous questions presented to the user by the system, with the system adjusting the user's proficiency level after each response to a question or item of informational content. For purposes of the present disclosure, a ‘set’ may include one or more items of informational content, such as questions. Further, the webpage may indicate a difficulty level for the informational content, and may also indicate a proficiency level for the user. The webpage may also indicate a relevance level and/or difficulty level for each question within a set. This information can help a user in obtaining access to informational content that is relevant to them and at an appropriate difficulty level for them within a category.

In accordance with embodiments of the present disclosure, a method is disclosed for ranking and presenting relevant informational content to a user at a difficulty level approximating the user's current level of understanding. The method may include presenting, to a user with a previously designated or previously calculated proficiency level represented by a numerical score, a predetermined amount of informational content where such informational content has both (i) a previously designated or previously calculated difficulty level represented by a numerical score, and (ii) a previously designated or previously calculated relevance level represented by a numerical score. The method may also include obtaining feedback from the user as to the difficulty of the informational content for the user. Further, the method includes calculating a new proficiency score for the user, at a computing device based on the feedback obtained from the user. The new proficiency score may be calculated by (i) obtaining the previously designated or previously calculated difficulty level of the informational content; (ii) obtaining the previously designated or previously calculated proficiency level of the user; (iii) generating a numerical score representing the user's proficiency with respect to the informational content, based upon the feedback obtained from the user; and (iv) generating a new proficiency score for the user, at the computing device. The new proficiency score may be a sum of the previously designated or previously calculated proficiency level and the generated numerical score. The method may also include calculating a new difficulty score for the informational content, at a computing device, based on the feedback obtained from the user. The new difficulty score may be calculated by (i) obtaining the previously designated or previously calculated difficulty level of the informational content; (ii) obtaining the previously designated or previously calculated proficiency level of the user; (iii) generating a numerical score representing the difficulty of the informational content with respect to the user, based upon the feedback obtained from the user; and (iv) generating a new difficulty score for the informational content, at the computing device. The new difficulty score may be a sum of the previously designated or previously calculated difficulty level and the generated numerical score. The method may also include obtaining feedback from the user as to the relevance of the informational content for the user; and calculating a new relevance score for the informational content, at a computing device, based on the feedback obtained from the user. The new relevance score may be calculated by (i) obtaining the previously designated or previously calculated relevance level of the informational content; (ii) generating a numerical score representing the relevance of the informational content with respect to the user, based upon the feedback obtained from the user; and (iii) generating a new relevance score for the informational content, at the computing device, wherein the new relevance score may be a sum of the previously designated or previously calculated relevance level and the generated numerical score. Further, the method may include selecting a new predetermined amount of informational content for the user based upon the user's new proficiency score; and providing the predetermined amount of new informational content, at the computing device, to the user via a display.

As those of skill in the art readily understand, the use of numerical scores to measure or reflect changes in difficulty levels, proficiency levels and relevance levels, as well as the rates of those changes, can be accomplished by numerous mathematical methods, wherein addition is only one example. By way of further example and not limitation, such mathematical methods include subtraction, multiplication, division, exponents and various techniques and elements of differential calculus.

In accordance with embodiments of the present disclosure, another method is disclosed for ranking and presenting relevant informational content to a user at a difficulty level approximating the user's current level of understanding. The method may include presenting, to a user with a previously designated or previously calculated proficiency level represented by a numerical score, a predetermined amount of informational content where such informational content has both (i) a previously designated or previously calculated difficulty level represented by a numerical score and (ii) a previously designated or previously calculated relevance level represented by a numerical score. The method also includes obtaining feedback from the user as to the difficulty of the informational content for the user. Further, the method includes calculating a new proficiency score for the user, at a computing device, based at least partly on the feedback obtained from the user. Obtaining feedback may include (i) obtaining the previously designated or previously calculated difficulty level of the informational content; (ii) obtaining the previously designated or previously calculated proficiency level of the user; (iii) generating a numerical score based upon the feedback obtained from the user; and (iv) generating a new proficiency score for the user, at the computing device. The new proficiency score may be a sum of the previously designated or previously calculated proficiency level and the generated numerical score. Further, the method includes calculating a new difficulty score for the informational content, at a computing device, based on the feedback obtained from the user. The new difficulty score may be calculated by (i) obtaining the previously designated or previously calculated difficulty level of the informational content; (ii) obtaining the previously designated or previously calculated proficiency level of the user; (iii) generating a numerical score based upon the feedback obtained from the user; and (iv) generating a new difficulty score for the informational content, at the computing device. The new difficulty score may be a sum of the previously designated or previously calculated difficulty level and the generated numerical score. The method may include selecting a new predetermined amount of informational content for the user based upon the user's new proficiency score. Further, the method may include providing the new predetermined amount of informational content, at the computing device, to the user via a display.

In accordance with embodiments of the present disclosure, another method is disclosed for ranking and presenting relevant informational content to a user at a difficulty level approximating the user's current level of understanding. The method may include presenting, to a user with a previously designated or previously calculated proficiency level represented by a numerical score, a predetermined amount of informational content where such informational content has both (i) a previously designated or previously calculated difficulty level represented by a numerical score and (ii) a previously designated or previously calculated relevance level represented by a numerical score. The method also includes obtaining feedback from the user as to the difficulty of the informational content for the user. Further, the method includes calculating a new proficiency score for the user, at a computing device, based at least partly on the feedback obtained from the user. Obtaining feedback may include (i) obtaining the previously designated or previously calculated difficulty level of the informational content; (ii) obtaining the previously designated or previously calculated proficiency level of the user; (iii) generating a numerical score based upon the feedback obtained from the user; and (iv) generating a new proficiency score for the user, at the computing device. The new proficiency score may be a sum of the previously designated or previously calculated proficiency level and the generated numerical score. Further, the method includes calculating a new difficulty score for the informational content, at a computing device, based on the feedback obtained from the user. The new difficulty score may be calculated by (i) obtaining the previously designated or previously calculated difficulty level of the informational content; (ii) obtaining the previously designated or previously calculated proficiency level of multiple users; (iii) generating a numerical score based upon the feedback obtained from the multiple users; and (iv) generating a new difficulty score for the informational content, at the computing device. The new difficulty score may be a sum of the previously designated or previously calculated difficulty level and the generated numerical score from each of the multiple users. The method may include selecting a new predetermined amount of informational content for the user based upon the user's new proficiency score. Further, the method may include providing the new predetermined amount of informational content, at the computing device, to the user via a display.

In an embodiment, various steps may be implemented to adjust the relevance score of an amount of informational content based upon an individual user's opinion of an item's or question's relevance. A first step includes obtaining feedback from the user as to the relevance of the informational content for the user. A second step includes calculating a new relevance score for the informational content, at a computing device, based on the feedback obtained in the first step. The second step may include (i) obtaining the previously designated or previously calculated relevance level of the informational content; (ii) generating a numerical score based upon the feedback obtained from the user; and (iii) generating a new relevance score for the informational content, at the computing device. The new relevance score may be a sum of the previously designated or previously calculated relevance level and the generated numerical score. The selection of the new predetermined amount of informational content may also be based upon the previously designated or previously calculated relevance level of the informational content.

In another embodiment, the relevance scores of multiple users may be gathered by the disclosed system prior to generating a new relevance score for informational content.

In another embodiment, the number of multiple users for which relevance feedback will be gathered prior to generating a new relevance score may vary by category within the system. Additionally, the number of multiple users for which relevance feedback will be gathered prior to generating a new relevance score may differ from the number of multiple users for which difficulty feedback will be gathered prior to generating a new difficulty score within the same category. The number of multiple users for which feedback will be gathered prior to generating new difficulty or relevance scores may be adjustable within the disclosed system, and may be dependent upon one or more factors such as the number of concurrent users, the settings established for one or more categories, or limitations in the system's ability to process the feedback of the multiple users.

In accordance with embodiments of the present disclosure, an interactive information system is disclosed. The system may include multiple information components each of which may comprise a question subcomponent and an answer subcomponent. The information components may be given a difficulty rank and relevance rank independently and based on input by one or more users of the system. The information components may be arranged by both difficulty and relevance rank. The difficulty and relevance rank may change over time based on additional user input. Further, users may be ranked based on their relative ability to answer questions correctly. The information components may be arranged into categories.

In accordance with other embodiments of the present disclosure, a computing system may rank and present relevant informational content to a user at a difficulty level approximating the user's current level of understanding. The system may include control logic having a receiving module for enabling a processor to receive information from a user at a computing device. The information may include feedback with respect to the difficulty, for the user, of a predetermined amount of informational content where such informational content has a previously designated or previously calculated difficulty level represented by a numerical score and a previously designated or previously calculated relevance level represented by a numerical score. The system may also include a first calculating module for enabling the processor to calculate, at the computing device, a new difficulty score for the predetermined amount of informational content. The new difficulty score may be at least partly based upon the user's interaction with the content. The first calculating module may be configured to obtain the previously designated or previously calculated difficulty level of the informational content, to obtain the previously designated or previously calculated proficiency level of the user, to generate a numerical score based upon the feedback obtained from the user, and to generate a new difficulty score for the informational content, at the computing device. The new difficulty score may be a sum of the previously designated or previously calculated difficulty level and the generated numerical score. Further, the system may include a second calculating module for enabling the processor to calculate, at the computing device, a new relevance score for the predetermined amount of informational content. The second calculating module may be configured to obtain the previously designated or previously calculated relevance level of the informational content, to obtain the relevance score provided by the user, and to generate a new relevance score for the informational content, at the computing device. The new relevance score may be a sum of the previously designated or previously calculated relevance score and the user-provided relevance score. In another embodiment, the user-provided relevance score for certain users may be multiplied by a factor larger or smaller than one, in order for such users to have larger or smaller impact on the relevance score of the informational content relative to other users.

In another embodiment, a computing system may rank and present relevant informational content to a user at a difficulty level approximating the user's current level of understanding. The computing system may collect the feedback from multiple users prior to generating a new difficulty score for the informational content. Similarly, the computing system may collect the feedback from multiple users prior to generating a new relevance score for the informational content. The number of users for which relevance feedback is collected prior to generating a new relevance score may be different from the number of users for which difficulty feedback is collected prior to generating a new difficulty score, either within a particular category or among categories. Further, the system may adjust any of these numbers of multiple users based on numerous factors as previously disclosed herein.

In accordance with embodiments of the present disclosure, a method for ranking and presenting relevant informational content to a user at a difficulty level approximating the user's current level of understanding. The method includes presenting a predetermined amount of informational content with a previously designated or previously calculated difficulty level represented by a numerical score and a previously designated or previously calculated relevance level represented by a numerical score to a user with a previously designated or previously calculated proficiency level represented by a numerical score. For purposes of the present disclosure, a ‘numerical score’, as well as the various other scores referred to herein, is not limited to numbers, and can comprise any mathematic or logical expression or representation that can be mathematically or logically used, controlled or manipulated, such as by a computing device. Further, the method includes obtaining feedback from the user as to the difficulty of the informational content for the user. The method also includes calculating a new proficiency score for the user, at a computing device, based on the feedback obtained from the user. Also, the new proficiency score may be calculated by (i) obtaining the previously designated or previously calculated difficulty level of the informational content; (ii) obtaining the previously designated or previously calculated proficiency level of the user; (iii) generating a numerical score based upon the feedback obtained from the user; and (iv) generating a new proficiency score for the user, at the computing device, wherein the new proficiency score may be a sum of the previously designated or previously calculated proficiency level and the generated numerical score. The method also includes calculating a new difficulty score for the informational content, at a computing device, based on the feedback obtained from the user. Further, a new difficulty score may be calculated by (i) obtaining the previously designated or previously calculated difficulty level of the informational content; (ii) obtaining the previously designated or previously calculated proficiency level of the user; (iii) generating a numerical score based upon the feedback obtained from the user; and (iv) generating a new difficulty score for the informational content, at the computing device. The new difficulty score may be a sum of the previously designated or previously calculated difficulty level and the generated numerical score. The method also includes obtaining feedback from the user as to the relevance of the informational content for the user. Further, the method includes calculating a new relevance score for the informational content, at a computing device, based on the feedback obtained from the user. A new relevance score may be calculated by (i) obtaining the previously designated or previously calculated relevance level of the informational content; (ii) generating a numerical score based upon the feedback obtained from the user; and (iii) generating a new relevance score for the informational content, at the computing device. The new relevance score may be a sum of the previously designated or previously calculated relevance level and the generated numerical score. The method may also include selecting a new predetermined amount of informational content for the user based upon the user's new proficiency score. Further, the method may include providing the predetermined amount of new informational content, at the computing device, to the user via a display.

In another embodiment, a new relevance score may be calculated by (i) obtaining the previously designated or previously calculated relevance level of the informational content; (ii) obtaining the relevance score provided by the user; and (iii) generating a new relevance score for the informational content, at the computing device. The new relevance score may be a sum of the previously designated or previously calculated relevance level and the user-provided relevance score. In another embodiment, the user-provided relevance score for certain users may be multiplied by a factor larger or smaller than one, in order for such users to have larger or smaller impact on the relevance score of the informational content relative to other users.

In an example application of the presently disclosed subject matter, a system and/or method as disclosed herein may be used for education. Use of the system may be free or fee-based. The system may rank and organize content and evaluate students in real-time. The informational content stored by the system may be ranked for difficulty and/or relevance to a particular subject or category. In some examples, the content may contain one or more questions, and a difficulty ranking for the question(s) may be adjusted based on whether the user correctly answers the question. If the user correctly answers a question, the student's proficiency ranking may increase, and the question's difficulty ranking may decrease. Likewise, if the student is incorrect, the student's proficiency ranking may decrease, and the question's difficulty ranking may increase. After each question, the student may be presented with the opportunity to rank the content for relevance relative to the particular category. After adjusting the student's proficiency rank, the system may select and present the most relevant learning material in the category that is at or near the new proficiency level of the student.

In an example, the system can be applied to virtually all material, categories or subjects that can be learned from a screen or book, including science, mathematics, engineering, social science, medicine and languages. While the initial objective is to optimize learning for all students, the system can enable other applications, such as the specific assessment of student achievement.

In an embodiment, a user may be guided along through progressively more difficult informational content to promote learning of the content. If a student has not used the system for an extended length of time in a given category or subject, the system may automatically guide the user to a lower level to resume their work at the optimal level.

In another embodiment, a system as disclosed herein may provide an environment where content authors can submit questions and users can answer questions to achieve awards. Further, achievement levels for individuals completing or progressing through informational content may be provided to students, for personal recognition or comparison to peers. Additionally, content authors may be recognized for contributing content that is deemed relevant by the student community. In an embodiment, both students and authors may obtain points or other rewards based on achievements within and contributions to the system.

To assist authors and instructors, various category types may be provided. For example, three example category types are ‘open’, ‘read-only’ and ‘closed’. ‘Open’ categories may allow anyone to add content. The ‘read-only’ category may lock the ability to add or modify content by anyone other than the content owner (e.g., a university professor or an employer), but may allow one or more students to view, rate and supply answers for content. ‘Closed’ categories may be opened to students on an ‘invitation-only’ basis, and thus may serve as a private learning content management system.

Example subjects include, but are not limited to, verbal (e.g., SAT® or GRE® verbal), vocabulary, math, geography, trivia and the like. Questions may be presented in one or more ways such as, but not limited to, multiple choice, true-false, multiple choice with pictures or true-false with pictures (e.g., for math, biology, art, and the like), multiple choice with audio and/or video, true-false with audio and/or video, fill-in-the-blank, and the like.

In an embodiment, a user may submit one or more questions for storage in a server or other computing device. For example, the user may submit the following: a question; one correct answer choice; one or more incorrect answer choices; and a category or subject. The user may also enter one or more of an answer explanation, additional categories or subjects, picture data, audio data, and video data. Additionally, questions may include partially correct answer choices, wherein students may receive some credit, but less than the credit received for the fully correct or optimal answer choice. Also, as an alternative to requesting a ‘correct’, ‘most correct’ or ‘optimal’ answer choice from users, questions may request or require users to place answer choices in order, such as from best to worst, least applicable to most applicable or in a correct sequence. Questions may alternatively ask the user to select the answer choice that is not correct or least correct. Other questions may allow users to select more than one answer choice, which may or may not be in an order in which they were selected by the user. Further, the number of points awarded by the disclosed system for a correct answer or a partially correct answer may be dependent on factors additional to the selection of the answer choice, such as the time taken by the user to respond.

### Example Applications

Set forth herein below is a description of an example application of the presently disclosed subject matter. In an example, when a question is answered by a user, a user score (“US”) may be affected. In an example, the difficulty of a question may determine how many points a user may get when the user selects the correct answer choice. In this embodiment, a user may obtain up to ten points for a correct answer, but no points are taken away for incorrect answers, so the user score US may remain the same or increase. Points may be obtained based on question difficulty in accordance with a table such as the following, wherein content difficulty is represented by a Question Difficulty Rank (“QDR”):

| Difficulty (QDR) | Score | |
|---|---|---|
| 0-10 | 1 | point |
| 10-20 | 2 | points |
| 20-30 | 3 | points |
| 30-40 | 4 | points |
| 40-50 | 5 | points |
| 50-60 | 6 | points |
| 60-70 | 7 | points |
| 70-80 | 8 | points |
| 80-90 | 9 | points |
| 90-99 | 10 | points |

In another embodiment, a user may receive an amount of points equal to the QDR or a defined proportion thereof, which may permit scores such as 37 or 83 instead of the 4 or 9 that may be awarded in the previous embodiment. As is readily apparent to one of ordinary skill in the art, many different scoring methodologies may be employed to award scores to users for answering questions. In a third embodiment, a user may have points taken away for incorrect answers, such that the US for an individual user may be either positive or negative. In a fourth embodiment, users may be ranked only on which questions they answer incorrectly. In a fifth embodiment, the positive or negative points awarded for various answer choices may reflect partial credit for certain answer choices. In a sixth embodiment, the positive or negative points awarded for various answer choices may be at least partially dependent upon the time taken by the user to respond.

A user rank (“UR”) may be calculated in real-time for each user for each category. In this way, UR may ‘float’ based upon how the user is responding to questions in the category. Also, UR may lend itself to interesting charting capabilities (e.g., the ability to graph UR over time, to show progress in a given category or subject, such as standardized test preparation). For each user, UR may be independently calculated for each category (for example, geometry), and may also be calculated for a defined super-category or group of categories (for example, Mathematics).

In an embodiment, various data may be captured for each user-question interaction. For example, various parts or all of the following information may be captured for each user (“U”) attempt at answering a Question (“Q”): a unique user identification number or sequence (“UID”); a unique question identification number or sequence (“QID”); the number of times this U has answered this Q; whether the U got the Q correct, incorrect, or partially correct; time taken by the U to respond; time & date stamp of the user-question interaction; UR, either or both pre- and post-response; US, either or both pre- and post-response; a Question Relevance Score (“QRS”, measuring the relevance feedback from users), either or both pre- and post-response; QDR, either or both pre- and post-response; and a unique interaction identification number or sequence (“IID”). This information may inform the user and question databases (UR, US, QRS, QDR). As those skilled in the art readily understand, the more comprehensive the overall data set is, the greater the types and depth of analysis that can be performed.

Question difficulty may be calculated in various ways. In one embodiment, only the first answer by each user is counted toward the question difficulty, because otherwise a ‘relevant’, ‘trick’ question may end up with a lower difficulty score than it should (i.e., once a user sees the trick, they will likely get it right the next time).

In another embodiment, question difficulty may be calculated by allowing each answer of each user to affect the question difficulty.

In another embodiment, a question difficulty score (QDS) may be determined by the rank of users both getting the question right and getting the question incorrect. Specifically, the user rank (UR) may be added to the QDS when the user incorrectly answers the question, and the quantity (100-UR) may be subtracted from the question difficulty score (QDS) when the user correctly answers the question. For example, if a user with a rank of 65 gets a question wrong, then the QDS may be increased by 65. If a user with a rank of 65 gets a question correct, then QDS may be decreased by 35. In this example, lower-ranked users answering a question correctly may lower the QDS substantially, and higher-ranked users answering a question incorrectly may similarly raise the QDS significantly. Lower-ranked users answering questions incorrectly and higher-ranked users answering questions correctly may have less impact on the QDS. An example formula for calculating a new QDS when a question is answered correctly may be the following:

New QDS=Old QDS+User Rank

An example formula for calculating a new QDS when a question is answered incorrectly may be the following:

New QDS=Old QDS+(User Rank−100)

In another embodiment, the QDS may be calculated without regard for the user rank of each user that answers a question; that is, the QDS becomes a difference between those users answering the question correctly and those users answering the question incorrectly (or with respect to other learning content, the difference between those users rating the content below their level of understanding and those users rating the content above their level of understanding). In yet another embodiment, there may be one or more ‘breakpoints’ in the rankings of the user community, whereby users with user ranks or other factors or characteristics above or below certain limits have more or less weighting than other user in determining QDS.

Question difficulty rank (QDR) may be determined in various ways. For example, the QDR may be determined by dividing the QDS by the number of times the question is answered. In this example, a user with a UR equal to the QDR may have approximately a 50% chance of answering correctly.

A Question Relevance Score (QRS) may also be determined. For purposes of a detailed discussion of this embodiment, QRS is used throughout, but this is not intended to limit the discussion of relevance to only questions; the relevance of any type of informational content could be similarly measured, or the QRS could alternatively be referred to as “CRS,” for Content Relevance Score. In this embodiment, the QRS is a running total of all relevance scores input by users responding to the content or question. In one embodiment, the default for users, if they do not make any choice, is zero. Because this embodiment is zero based, and reflects the choices of individual users, it may be possible to simply use the total QRS as the relevance rank in the question selection process, on the thinking that questions with a long history of relevance should stay near the top. However, certain questions may be highly relevant but subject to becoming outdated, such as, “who is the current President of the United States?”, so an advanced system will have a mechanism for dealing with that eventuality. One way to do this is to look at the divergence between the total QRS and the most recent relevance scores of a set number of users (e.g., 10). Another way to evaluate and/or maintain question relevance is to create and maintain an average QRS, and examine the divergence of the average QRS between two different user groups (e.g., all users and last ten, or 100, or 1000, etc.). A total or average QRS could be calculated and maintained by the system for a specific group or user community. In addition, a total or average QRS could be calculated and maintained by the system to identify trends or to obtain data for research by surveyors of popular opinion. Another option is to provide a pop-up for users supplying low relevance rankings e.g., (−3), where users can give a reason such as “Not Accurate”. In an embodiment, the system may treat content receiving a low relevance ranking with a user designation of ‘Not Accurate’ differently than content receiving only a low relevance ranking

In one embodiment, experienced users may be invited to review new questions or informational content ahead of the regular user population, to eliminate inferior questions or informational content earlier. In this mode, these experienced users may receive a multiplier or exponential effect (e.g., 3x, 10x or x³, or a combination thereof, where x is the normal relevance score for the user), applied to their relevance scores for new questions or content. A multiplier or exponential effect may allow questions or content to obtain very high or very low relevance with a limited number of users. Alternatively, in place of a multiplier or exponential weighting, experienced users may be provided with a greater range of scoring options. In another embodiment, a review mode may be employed whereby new questions or content failing to obtain a minimum score from one or more experienced users are not provided to the regular user population. In a third embodiment, experienced users that are reviewing questions or other informational content may be allowed to enter or attach comments to the question or content, and may be able to contact the author or other reviewers or users.

In an embodiment, users may be provided points or other credit for writing relevant questions or otherwise providing relevant informational content. For example, an author may receive up to a limited number of points (e.g., 100 points) per relevant question; that is, he or she may receive the highest relevance score (highest QRS) of each of their questions up to +100, with no subtraction for negatively-ranked questions.

In another embodiment, authors may receive unlimited relevance points per question. In further embodiments, authors may receive negative relevance points as well as positive, and/or may receive only one point, positive or negative, per user.

In another embodiment, the points an author receives from a user for a particular relevant question may be different than the number of relevance points awarded to the question by the user. In another embodiment, the user may choose to award extra or bonus points to an author and/or question, and the system may provide a limited number of bonus points per user and/or per unit of time, such as but not limited to per session, per hour, per day, per week, per month, per quarter and per year.

Hacking and identity theft are well-known to those of skill in the art, and social media platforms such as the presently disclosed system are not immune from such attacks. The relevance of questions may be useful in limiting the damage to a user account that has been hacked or otherwise compromised. For example, if a hacker takes over a user account and begins submitting questions or content that are threatening, offensive, contain spam or are simply not relevant to the category, the system can use the non-relevance of these questions or content to lock the account automatically, limiting the damage that can be caused. For example, a cumulative score below a certain cutoff for a certain number of questions (e.g., a score of −100 for the last 10 questions) can be used to lock the account. Other uses of this automatic locking feature can be implemented in other areas of the system, such as if a user uses forbidden or offensive language, their account may be automatically locked, or they may be prohibited from communicating with others. As can be readily understood by those in the art, the automatic locking features described herein can be established by the system, adjusted by each user, or a combination thereof, and may apply to the entire user account or to only one or more parts of an account (e.g., authoring, communicating with others, etc.). In an example, a system may determine whether a relevance level of informational content associated with another user meets a predetermined threshold. In response to the determining that the relevance level meets the predetermined threshold, a user may be prevented from submitting additional informational content.

In one embodiment, individual users may receive points toward their user score for all activity, including answering questions, authoring questions, and otherwise interacting with the system (viewing advertisements, answering polls, etc.). In another embodiment, users receive points toward scores for individual categories of interacting with the system, i.e., student points for answering questions or rating content, author points for writing and submitting questions, sponsor points for viewing advertisements, survey points for answering surveys, and the like. In yet another embodiment, users may obtain awards from the system by achieving point levels in one or more categories in a form of contest or challenge, which may or may not have a deadline or time limit. In still another embodiment, users may establish contests or issue challenges for other users, specifying what users must do within the system in order to win the contest or challenge.

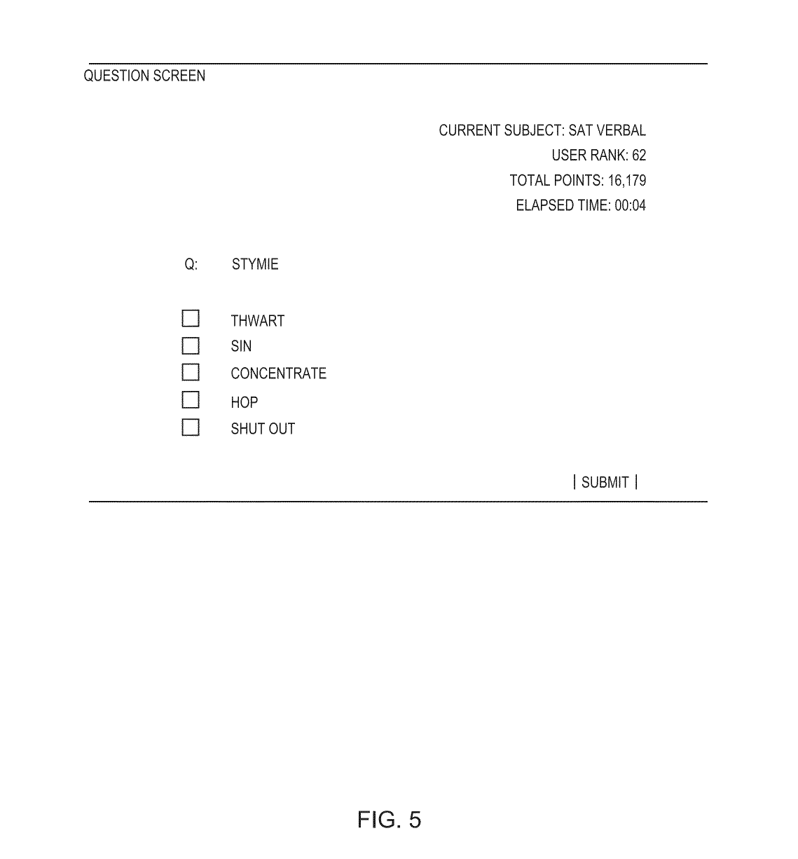

FIG. 5 illustrates a screen display showing an example question screen in accordance with embodiments of the present disclosure. Referring to FIG. 5, the user is presented with an answer and multiple choices for answering the question.

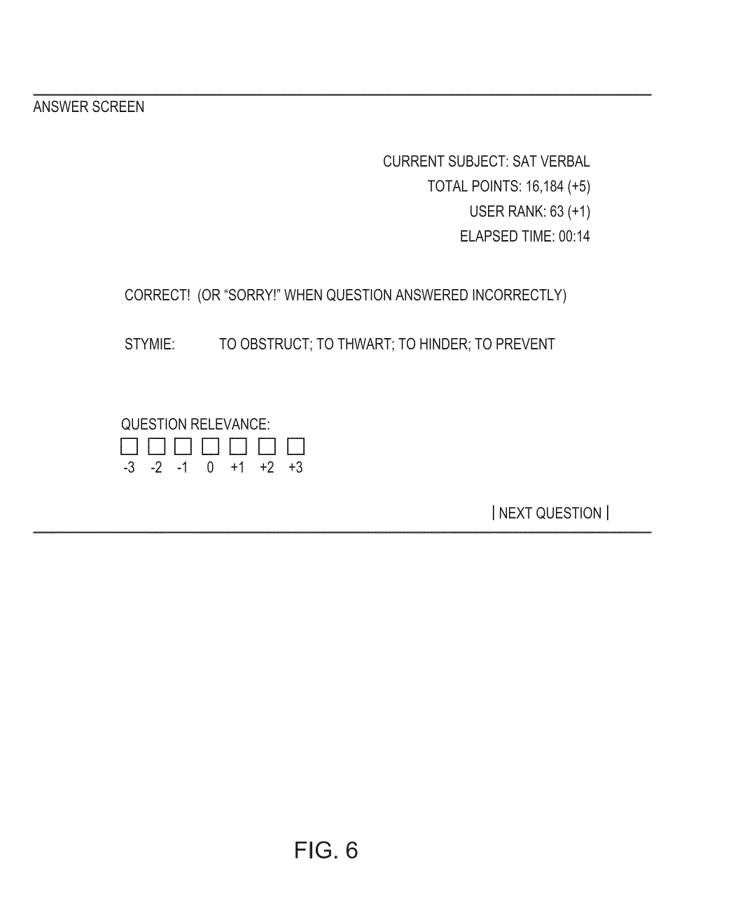

FIG. 6 illustrates a screen display showing an example answer screen in which the user has responded to the question of FIG. 5. Referring to FIG. 5, the screen display indicates that the user correctly answered the question, and queries the user for a indicating a relevance of the question on a scale from −3 to +3. Each user may have the option of selecting a relevance rank between −3 and +3. If no selection is made, the default value may be 0. If the user selects a positive value, the question may be added to the user's “Review List”, which consists of questions that can be repeated for the user. Such “Review List” questions may be repeated on one or more frequencies that may be based upon factors such as how relevant the user ranks particular questions, whether and when the user answers such questions correctly, and how quickly the user answers each repetition of each question. As those of skill in the art readily understand, various frequency formulas may be implemented. In one embodiment, re-presentations of a question to a user may contain or default to the user's previous relevance ranking, which the user may change to a new value. In this example, if the user changes their relevance score for the question, the frequency at which the question is presented to that user may change, but this user's impact on the relevance score of the question may not change, i.e., only the first relevance by a user may affect the question's relevance score in the database.

In another embodiment, the relevance scores of questions can be updated by each user, and the system may use the revised scores to determine the relevance scores of questions. In another embodiment, the decision of whether to use the first or last relevance scores in determining relevance for informational content or questions may be determined by each user, on a category-by-category basis, or a combination thereof.

Each user may have a table with all questions they have answered, together with the relevance they have assigned to the question. This may allow a detailed analytics regarding the relevance history of questions, which may be valuable to users, survey professionals or others. Users may be able to select other users whose contributions or opinions they value, and rank questions within one or more categories based on these other users or groups. One example would be for a user to select their teacher or professor, and be able to sort questions in the teacher's or professor's subject based on the relevance provided by the teacher or professor. Another example would be for a user to affiliate with groups and see what informational content or questions the group prefers. It may be valuable to users to be able to ‘subscribe’ to authors, other users, or user groups (e.g., affinity groups), or to be able to sort or screen questions or other content based on the relevance provided by any of the above.

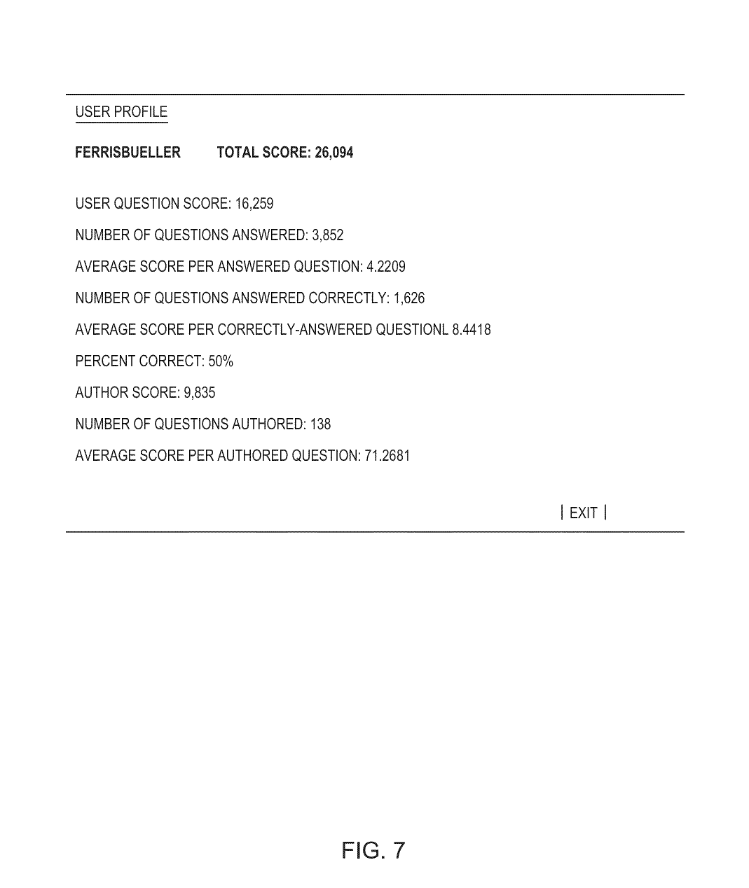

FIG. 7 illustrates a screen display of an example user profile in accordance with embodiments of the present disclosure. Referring to FIG. 7, various information of a user profile is presented.

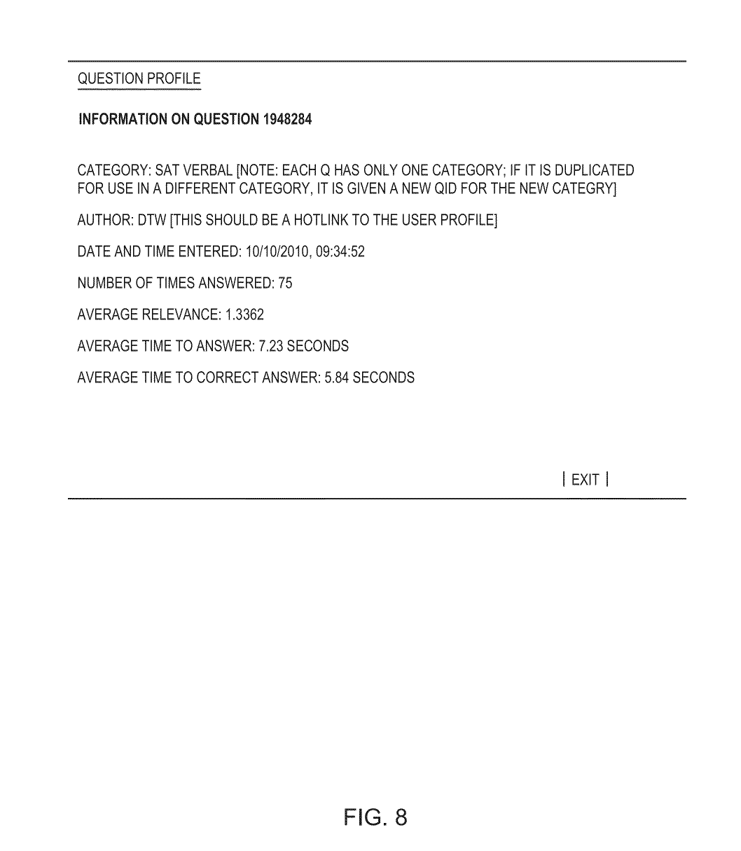

FIG. 8 illustrates a screen display of an example question profile in accordance with embodiments of the present disclosure. Referring to FIG. 8, various information of a question profile is presented.

In one embodiment, users may receive one of the following: (1) the most relevant untested question with a question difficulty rank (QDR) matching the user rank (UR)'s difficulty level; or (2) a previously-provided question deemed relevant by the user. Content and questions may be ranked on both relevance and difficulty in real-time. By way of illustration and not limitation, a question may move around the following hypothetical table based on users' interaction with the database, with increasing ordinal numbers denoting the question's path through the database, and with “Rely.1” denoting the most relevant question for a given QDR, “Relv.2” denoting the second-most relevant, etc.:

| QDR | | | | | |
|---|---|---|---|---|---|
| (0-100) | Relv. 1 | Relv. 2 | Relv. 3 | Relv. 4 | Relv. N |
| 68 | | | | | |
| 67 | 1^{st} | 3^{rd} | | | |
| 66 | 4^{th} | 2^{nd} | | | |
| 65 | | 5^{th} | | | |
| 64 | | | 6^{th} | | |
| 63 | | | | | |

In an embodiment, a new user may initially see a question with a QDR of 50. If they answer it correctly, the next question may have a QDR of 75; if they answer it incorrectly, they may see a question with QDR 25. The disclosure included herewith provides an example implementation of the presently disclosed subject matter. Assuming that the user gets this second question correct, they may then be presented with a question of QDR 37 (i.e., splitting the difference between 25 and 50, and rounding down). Assuming that they get this third question correct, too, they may then be presented with a question of QDR 43 (again, rounding down; the bias in this example is to have the user get more right than wrong).

In this example, within 5 questions, a preliminary user rank (UR) has been established. After the first five questions, the user rank may adjust based on winning streaks or losing streaks (several correct answers in a row may increase the difficulty, and several incorrect answers may lower the difficulty). As will be apparent to those of skill in the art, the speed at which difficulty increases for streaks of correct answers and the speed at which difficulty decreases for streaks of incorrect answers, as well as the number(s) of questions that constitute streaks, may be either provided by the system, adjusted by the individual user or a combination thereof.

In one embodiment, content is matched to users by first matching the question difficulty (QDR) to the user rank (UR), then by selecting the most relevant question at that QDR. In another embodiment, content is matched to users by selecting a range of QDR relative to the UR, such as ‘within two points above or below the UR’, then by selecting the most relevant question in that range. In yet another embodiment, content is matched to users by ranking material first by relevance, and then by difficulty, and then presenting content to users based primarily on the basis of relevance, whereby content is segmented into groups based on relevance, and whereby each group is presented to users in decreasing order of relevance, and whereby content may or may not be ordered for each user within each relevance group on the basis of difficulty. In yet another embodiment, content is matched to users by assigning relevance and difficulty different and independent weighting factors, and then by selecting and presenting content based on those weighting factors. Such weighting factors may be assigned by the system, or may be adjustable by the user, or a combination thereof. As those skilled in the art will readily understand, there are many ways of combining the relevance and difficulty of material and matching it in a meaningful way to users with a given user rank.

In an example, the difficulty of material presented to a user may be adjusted based on various factors. For example, if it is desired that a user answer more questions correctly than incorrectly, then the system or a user may establish a bias, whereby the rate of decrease in difficulty for a string of incorrect answers would be greater than the rate of increase for a string of correct answers. In such an example, users may reach a difficulty level where they get perhaps three correct answers for every two incorrect ones. Alternatively, it may be desired that users answer more questions incorrectly than correctly; in such a case, the bias may be set where the rate of decrease in difficulty for a string of incorrect answers would be less than the rate of increase for a string of correct answers, resulting in perhaps two correct answers for every three incorrect.

In another embodiment, users may be able to set the bias described in the previous paragraph either quantitatively (e.g., four correct answers for every three incorrect answers, or one correct answer for every two incorrect answers) or qualitatively (e.g., selecting from choices that may say ‘Take it Easy on Me’ or ‘Really Challenge Me’). As those skilled in the art will understand, the bias described herein could be set to represent any ratio of correct to incorrect responses, and could be applied by a user to an individual category, a group of categories, an individual session (similar to a physical workout) or as a universal setting for the user, to be applied to all categories and sessions.

In another example, the rate of increase may be much less for lower-ranked users, e.g., for a UR below 20, it may take 4 right answers to increase difficulty 1 point, and difficulty may only increase 1 point at a time until the user is over the 20 UR threshold. Similarly, higher-ranked users may require more incorrect answers to lower their UR. In one or more embodiments, any of the rates of increase or decrease in UR for users of various ranks may be provided by the system, automatically adjusted by the system, modified by each user, or any combination thereof.

In another example, each user may have a certain number of questions they have ranked with a positive relevance. As discussed earlier herein, those questions may be associated with the user by way of the user's review list. In one embodiment, the user may be able to get points and improve their ranking for answering a question correctly on the 2^{nd}, 3^{th}, etc. subsequent presentations, even though the user may have seen the question before. Alternatively, a user may be able to obtain points but obtain no change to their ranking for answering a repeated question correctly, or the reverse, whereby the user obtains no points but does obtain a change to their ranking. As stated before in one embodiment previously presented, additional or repeated answers of a question by the user may have an effect on the question difficulty rank (QDR), depending on whether subsequent answers are correct, partially correct or incorrect, but in another embodiment previously presented, the user's subsequent answers would have no effect on the QDR. In another embodiment, users may affect both their user score US and their user rank UR for answering a repeated question. In another embodiment, users may affect neither their user score US nor their user rank UR for answering a repeated question. In yet another embodiment, the ability of repeated questions to affect either or both of user score US or user rank UR may be a setting that can be adjusted by or for individual users, individual sessions of individual users, or globally for all users.

Example formulas for calculating user values follow:
For a question answered correctly: Question Points=QDR/10
For a question answered incorrectly: Question Points=0
New User Score=Old User Score+Question Points
For first two questions in a category: Rank Delta (change)=+10 for correct answer, and −10 for incorrect answer
For questions 3-5: Rank Delta (change)=+5 for correct answer, −5 for incorrect answer
For questions 6 and higher:
For correct answer: Rank Delta (change)=Current correct streak−2 (if streak>2)
For incorrect answer: Rank Delta (change)=−(Current incorrect streak−1) (if streak>1)
New User Rank=Old User Rank+Rank Delta (change)

In one embodiment, a question's relevance would be unaffected by whether the user changes their relevance ranking in subsequent presentations of the question. However, if a user changes the relevance ranking, it may affect the refresh rate. As far as the degree to which the user's relevance score affects the placement of the question in the user's review list, the following table may be used initially. As is readily apparent to one of ordinary skill in the art, these values are only one representation of many possible illustrations of the review list concept, and the system may permit each user to adjust this information as they see fit.

| User-assigned Relevance | User's Review List |
|---|---|
| Score | Countdown Timer |
| −3 | N/A |
| −2 | N/A |
| −1 | N/A |
| 0 | N/A |
| 1 | 1000 |
| 2 | 500 |
| 3 | 250 |

In one embodiment, questions marked as relevant by a user may be added to the user's review list, and assigned an initial repeat frequency (i.e., countdown timer) of 1000, 500 or 250 questions, as shown in the preceding table. If a user gets the re-presented question incorrect, it is assigned a new repeat frequency of half the previous repeat frequency (e.g., 500 questions if the initial frequency was 1000); if correct, the repeat frequency doubles (e.g., becomes 2000 in this example). In this example, the question stays in the review list until it is answered correctly three times in a row, with each answer submitted in less than the average time for correct answers for the particular question. The average time to correct answer for each question may be tracked.

In another embodiment, users may adjust the review frequencies for one or more questions in their review list on a collective basis, in groups of questions or individually. In another embodiment, users may choose to adjust the rate of change in the review frequencies (e.g., instead of the review frequency doubling (2x) after a correct answer, it may be 2.5x, 3x or any other amount, and instead of the review frequency being halved (½y) after an incorrect answer, it may be ⅓y, 0.3y or any other amount). In still another embodiment, the review frequencies may be adjusted by the system automatically for one or more questions, on the basis of one or more of the following factors: prior experience of the user, category, difficulty level, and the experience of one or more other users that may or may not be affiliated with each other, a common user or group of users.

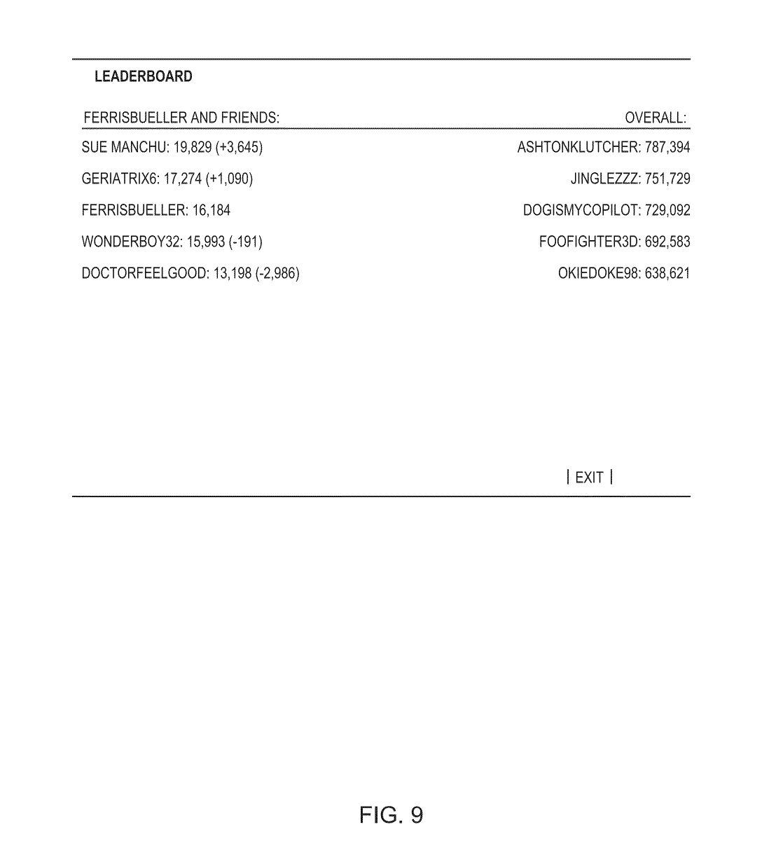

In an example, a user may access a leaderboard that shows the overall point leaders for the particular category or overall. FIG. 9 illustrates a screen display of an example leaderboard in accordance with embodiments of the present disclosure.

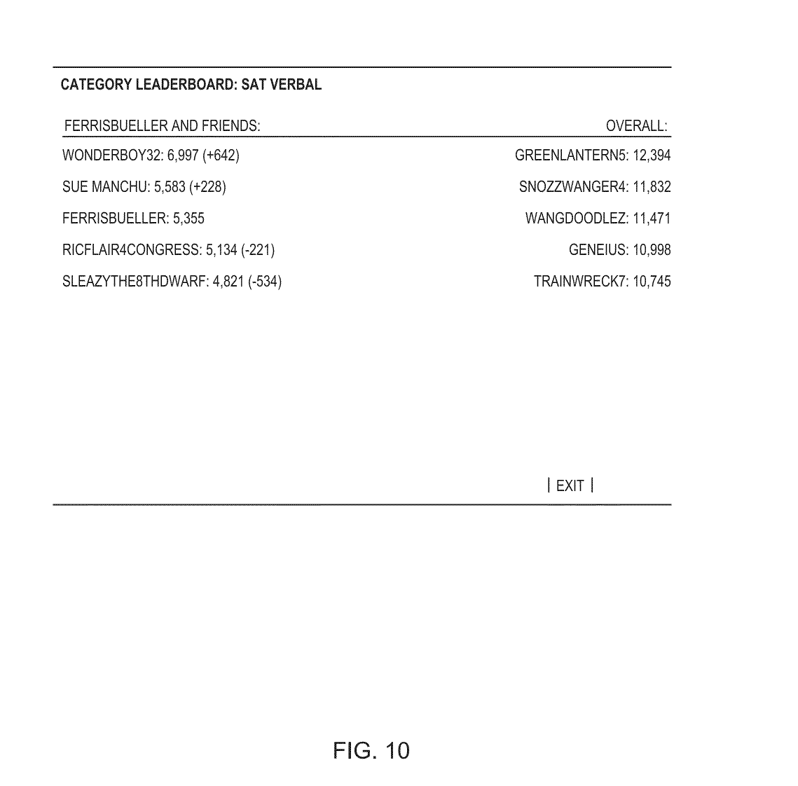

FIG. 10 illustrates a screen display of another example leaderboard in accordance with embodiments of the present disclosure.

In an example, a user Joe is a programmer. In this example, Joe is a really good programmer that can write code in several currently-popular languages. Joe recently saw a job opening for an in-house programming position, where he noticed that the company uses the presently disclosed system for training and skills validation. Joe wants to stand out from other applicants, so he decided to start answering questions in the presently disclosed system, and in two weeks, he has achieved an expert level in proficiency in programming, according to the system, by answering over 500 questions. At this point, the company may be interested in hiring Joe, at least partly on the basis of his expert ranking in one or more categories valued by the company.

In an example, corporate subscribers can select the fields they wish to validate, and the system can prepare an online test of, e.g., 50 or 100 statistically-validated questions in that field (or fields). The programmer Joe could then take the test, and the system can report a score and confidence level, which can then be compared to Joe's score and/or self-reported résumé. The disclosed system thus allows users to achieve an objective skill level of interest to potential employers, and the employers can then use the disclosed system to develop a test to validate the applicant's skill level.

Similarly, prospective students could use the system to obtain proficiency levels in areas of interest to colleges and universities, and the colleges and universities could validate the results with the disclosed system. Such colleges and universities could use the results in a number of ways, such as to assist in the admissions process, to determine if students are sufficiently prepared for individual courses, and even to grant credit for courses and pre-requisites. Since User Rank is a measure of skill, and User Score is a measure of effort, and since each can be reported over a period of time, a teacher, parent or other interested party can gain insight into the overall performance of a user.

The disclosed system may also be used to support K-12 classroom activities, such as end-of-grade testing, whereby teachers could supply questions of representative difficulty hosted by the system, and use the system to monitor student performance. In similar fashion, the disclosed system can be used for standardized test preparation, since a student's UR in a category corresponding to a standardized test would provide the student with insight with respect to their progress. Such student UR may be of value to parents in assessing the abilities and progress of their child, as well as in the identification of areas of relative strength or desired improvement.

In another example, an objective is to provide positive encouragement to users, in the form of rewards such as ‘belts’, ‘stripes’ and ‘stars,’ as well as congratulatory messages on achieving certain levels of proficiency. Each of the awards described below would be represented electronically within the system, and are disclosed by way of example and not limitation. Since the system can test users at the level of their capability, it is expected that they may get many questions wrong, but a continuous thread of positive feedback can keep them motivated.
Belts: Using a colored-belt ranking system similar to martial arts, users can always know how much they have achieved with the system. Points are awarded for each correct question, which may include bonus points for speed and degree of difficulty. Points needed for given belt levels may get larger as the user gets higher in the system. It may take average users more than a year of normal use to get to a desired level such as the black belt level, so that users may realize that it's not easy, and thus the achievement is worthwhile.
Stripes: Because of the time horizon between belts may be on the order of weeks or months, stripes or other motivational awards may be awarded on a more frequent basis, so that users may get a more timely sense of achievement. It is possible that stripes could be awarded for special achievements or particular categories of questions, or just a set level of points.
Stars: Stars may be given for subject matter expertise or other achievements. Different colors may be given for different subjects or categories. Different levels could also exist; ‘stars’ mean that someone is in the top 20%, ‘super stars’ mean top 10%, ‘ultra stars’ mean top 5%, and ‘shooting stars’ could mean top 2%. Alternatively, stars may indicate streaks of consecutive correct answers.
Medals, Ribbons and other awards: Medals, ribbons and other electronically-represented awards may be awarded by the system or other users, such as teachers that use the system in connection with their students, to denote achievements or a desired level of effort. Alternatively, awards such as those described herein may be awarded for satisfying the criteria of such things as a game provided by or within the disclosed system, a contest sponsored by a sponsoring organization or a challenge developed in connection with a school project or event.
Trophy case: Each user may have their own personal trophy case that shows their past and current achievements. This allows users to build a longer-term relationship with the system, so that they use it over many years. In another example, the system may send notices to users when their use falls off, perhaps referring to elements of their past usage history, age, etc., or to send sample questions to their email address to bring them back to use the system.
DIALOGUE™: In an embodiment, the system may provide a method of measuring and reporting student achievement to interested adults. This will allow others (teachers, guidance counselors, parents, grandparents, employers, etc.) to see how a student or employee is progressing, either overall, or in a given subject. The system can send them a report on a periodic basis, or they can be given a read-only ‘window’ into relevant parts of the user's profile. Of course, this access will be controlled by the users, but such an arrangement would allow parents and others to have an unbiased report from the system as to how the user is performing.

The following is a listing of example point levels for belts:

| Belt level | Point range |
|---|---|
| White | 0-10,000 |
| Orange | 10,001-20,000 |
| Yellow | 20,001-35,000 |
| Sr. Yellow | 35,501-50,000 |
| Green | 50,001-75,000 |
| Sr. Green | 75,001-100,000 |
| Blue | 100,001-175,000 |
| Sr. Blue | 175,001-250,000 |
| Purple | 250,001-375,000 |
| Sr. Purple | 375,001-500,000 |
| Red | 500,001-750,000 |
| Sr. Red | 750,001-1,000,000 |
| Black, 1^{st} degree | 1,000,001-2,000,000 |
| Black, 2^{nd} degree | 2,000,001-3,000,000 |
| Black, 3^{rd} degree | 3,000,001-4,000,000 |
| Black, 4^{th} degree | 4,000,001-5,000,000 |
| Black, 5^{th} degree | 5,000,001-6,000,000 |
| Black, 6^{th} degree | 6,000,001-7,000,000 |
| Black, 7^{th} degree | 7,000,001-8,000,000 |
| Black, 8^{th} degree | 8,000,001-9,000,000 |
| Black, 9^{th} degree | 9,000,001-10,000,000 |
| Black, 10^{th} degree | 10,000,001+ |

Trophies may be awarded to the top 10% of all users on various bases. For example, for top ranking and total points, past and current users may be able to obtain awards within the system such as the following:
Top 2%: Gold trophy
Top 2-5%: Silver
Top 5-10%: Bronze
   Current trophies may be electronically represented by the system as larger and brighter than those of past holders. As previously discussed, medals, stars, ribbons and other awards might be awarded for performance in specific categories, contests or events.

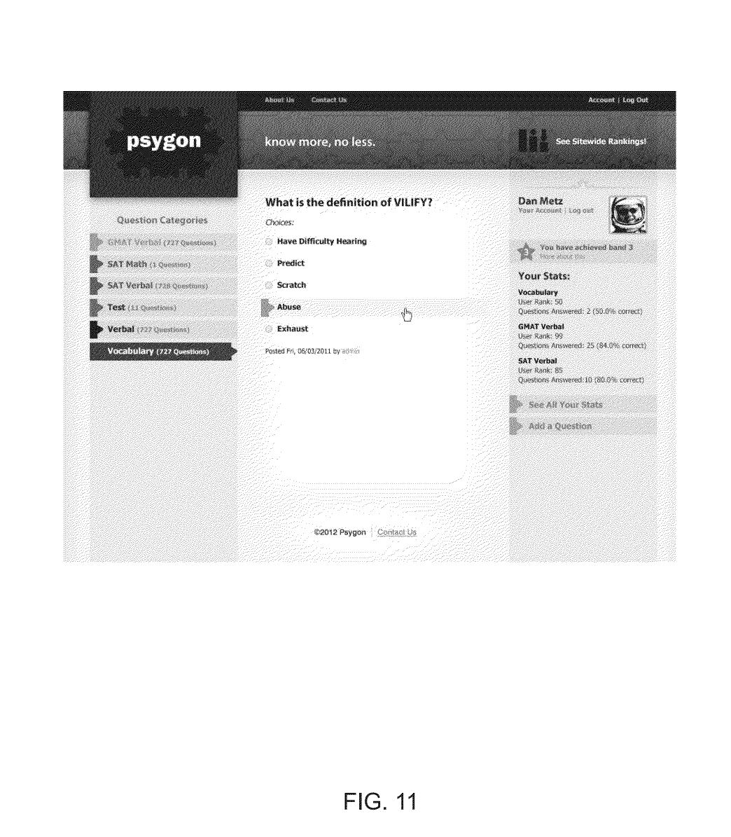

FIG. 11 illustrates a screen display of another example in which a user may input an answer to a question in accordance with embodiments of the present disclosure. Referring to FIG. 11, the screen display shows various categories and a user profile of the user.

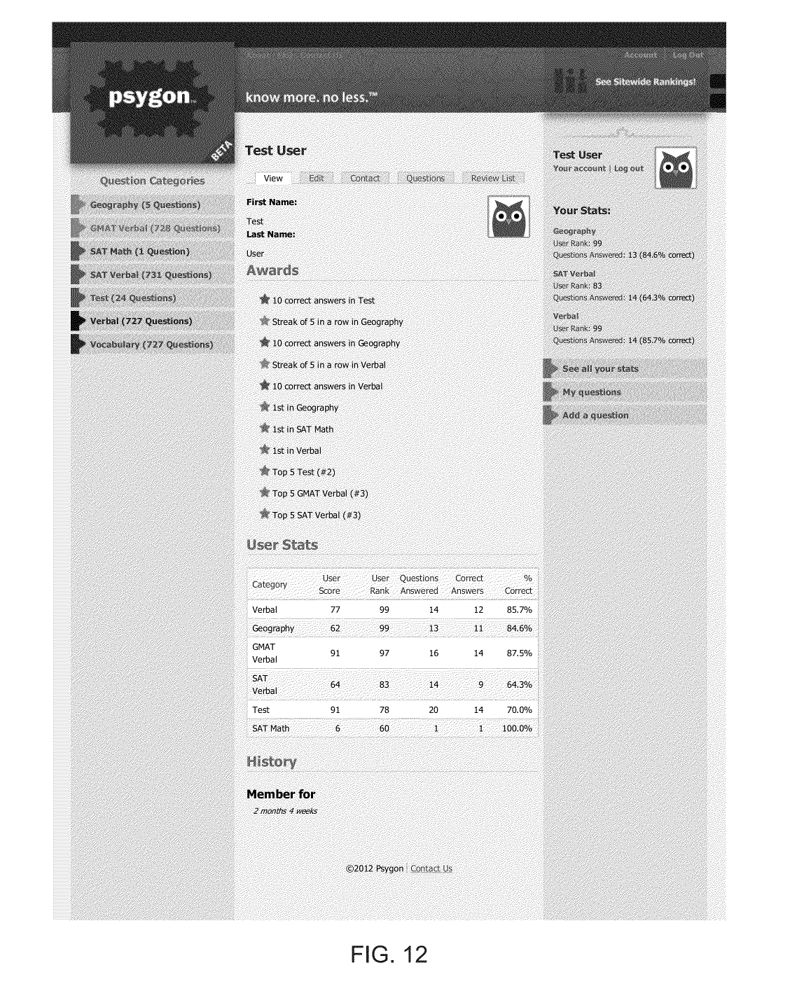

FIG. 12 illustrates a screen display of another example in which some awards and user statistics for a user are displayed in accordance with embodiments of the present disclosure.

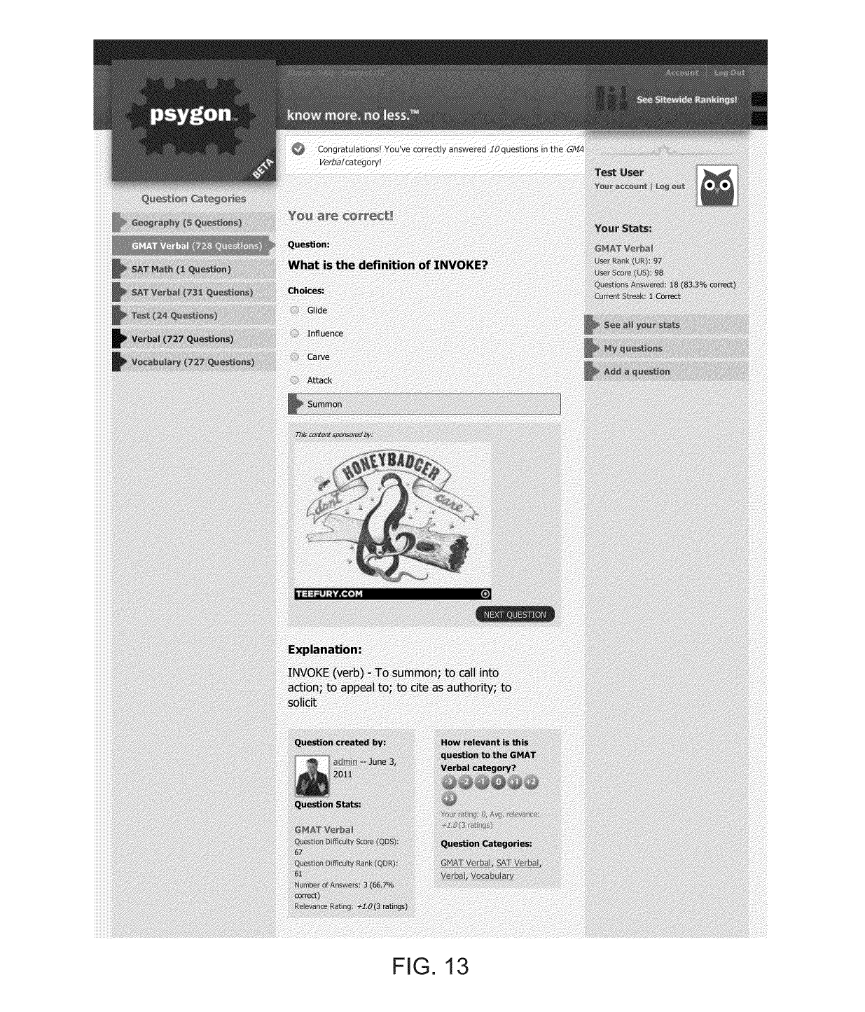

FIG. 13 illustrates a screen display of another example in which a question is presented to and answered by a user in accordance with embodiments of the present disclosure. Referring to FIG. 13, the screen display also shows an explanation of the answer to the question.

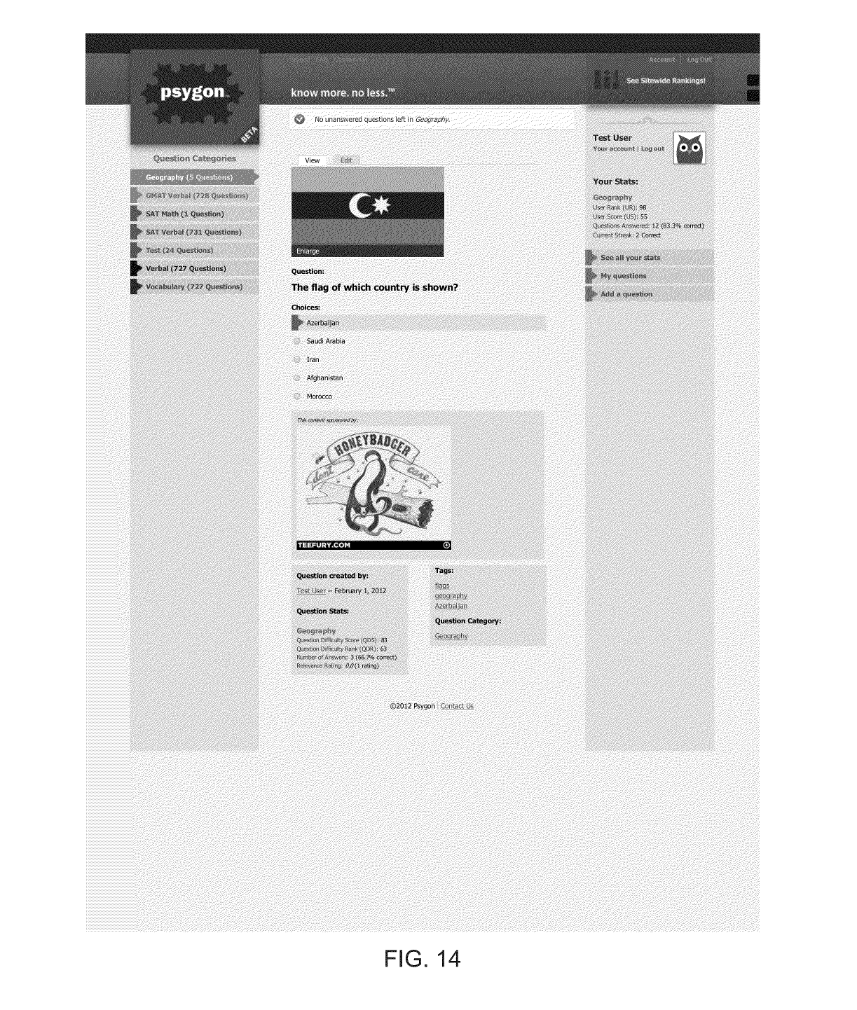

FIG. 14 illustrates a screen display of another example in which a question is presented to and answered by a user in accordance with embodiments of the present disclosure. Referring to FIG. 14, the screen display also shows an explanation of the answer to the question.

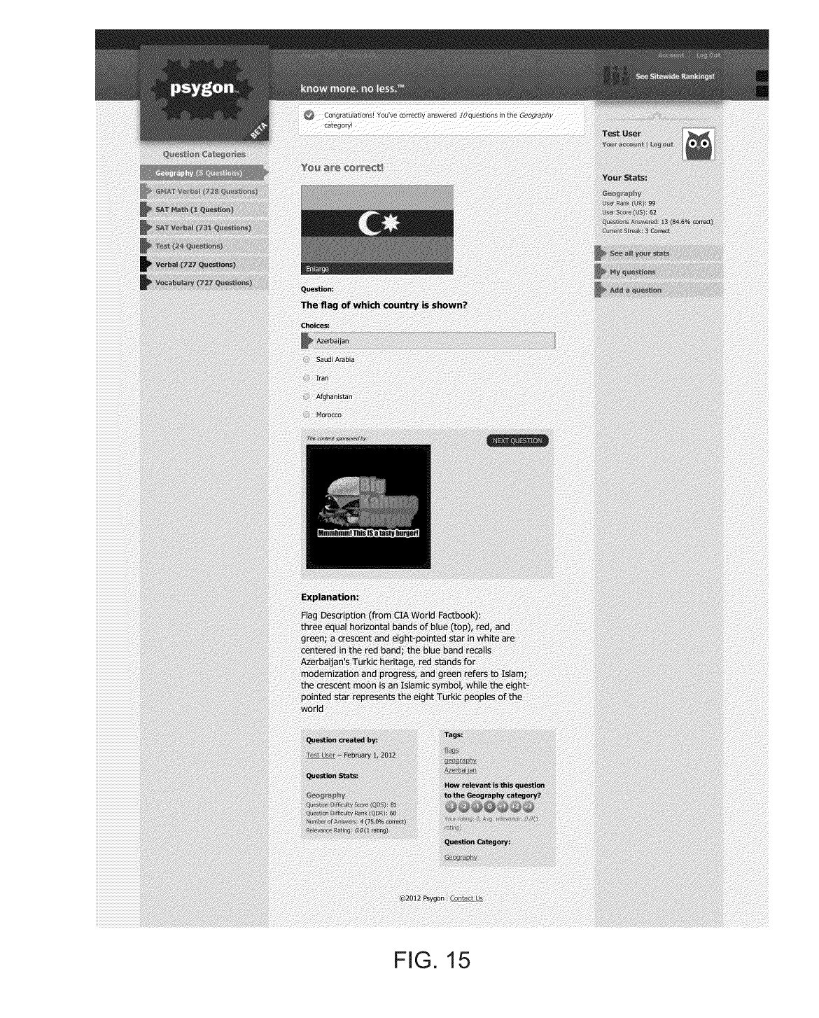

FIG. 15 illustrates a screen display of another example in which a question is presented to a user in accordance with embodiments of the present disclosure. Referring to FIG. 15, the screen display also provides information for identifying the question creator, question statistics, tags, and a category.

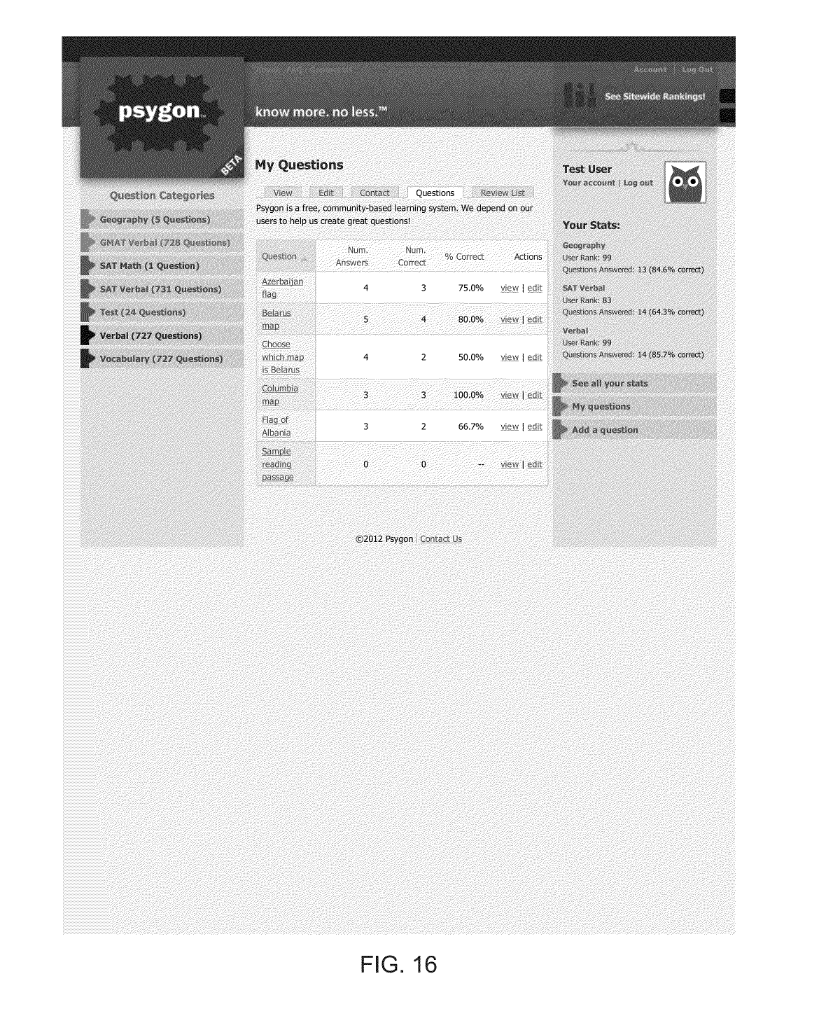

FIG. 16 illustrates a screen display of another example in which information about questions for a user is presented in accordance with embodiments of the present disclosure. Referring to FIG. 16, the screen display presents, for each question, a number of answers for the question, a number of correct answers for the question, and a percent correct for the question.

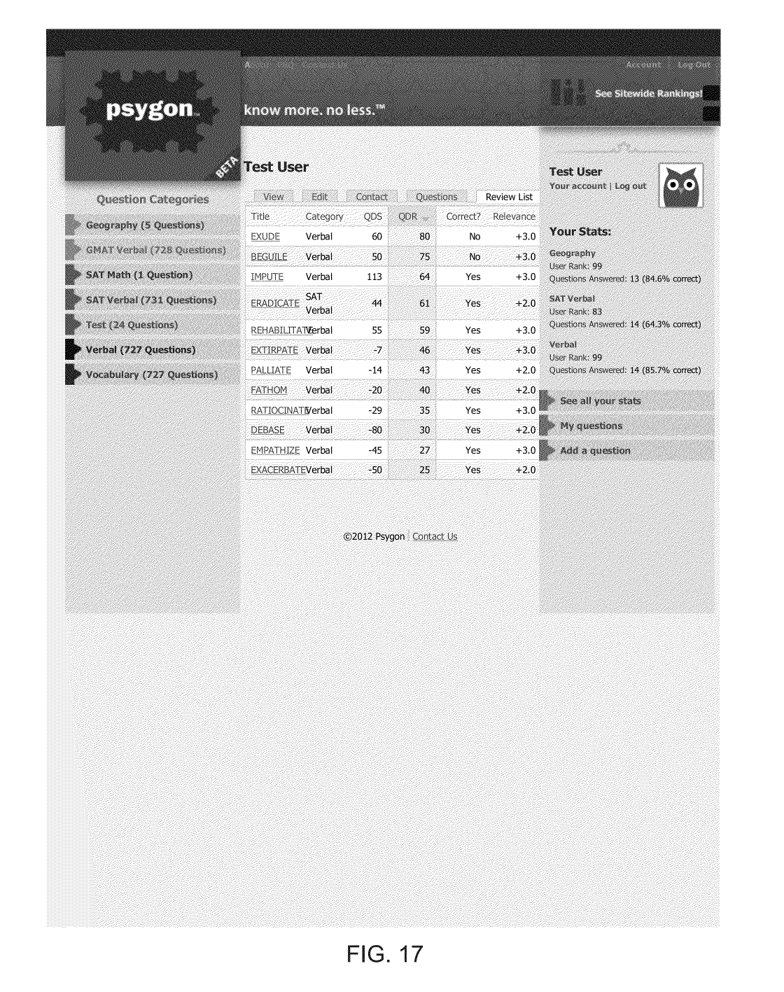

FIG. 17 illustrates a screen display of another example in which information about a user's review list is presented to a user in accordance with embodiments of the present disclosure. Referring to FIG. 17, the screen display presents, for each question, its category, QDS, QDR, correct indication, and relevance level.

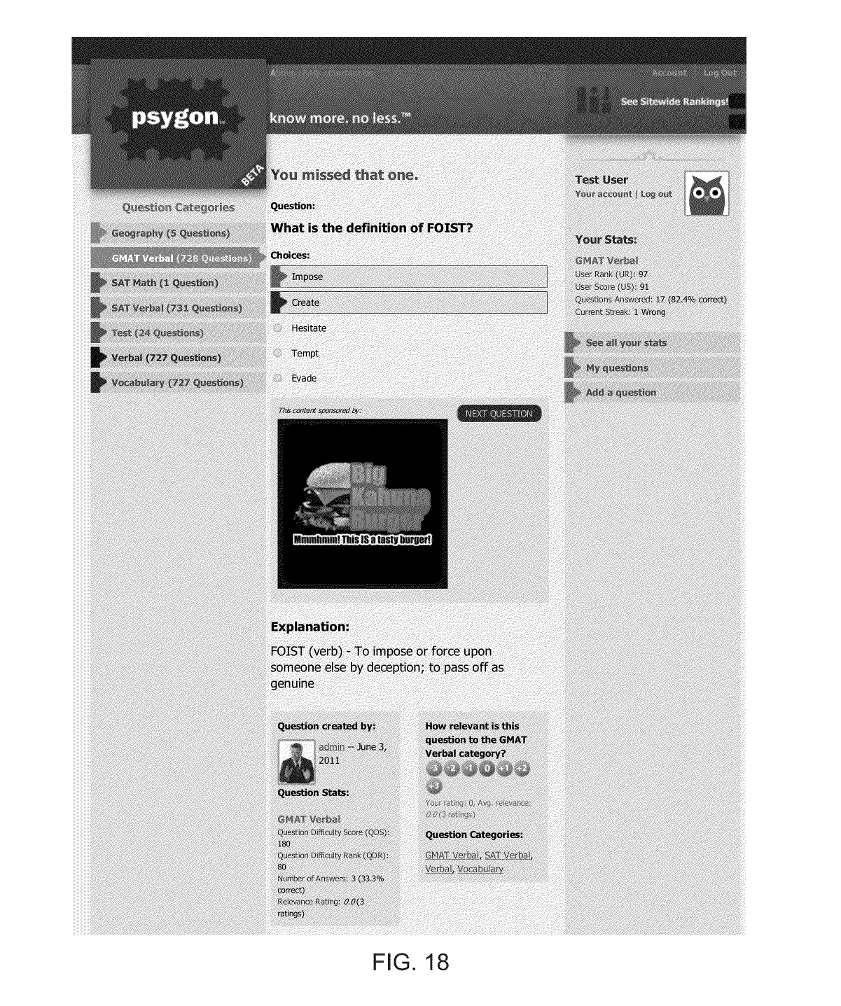

FIG. 18 illustrates a screen display of another example in which a question, a user's answer, and an indication of the correct answer is presented to a user in accordance with embodiments of the present disclosure. Referring to FIG. 18, the screen display presents a definition for the term presented in the question.

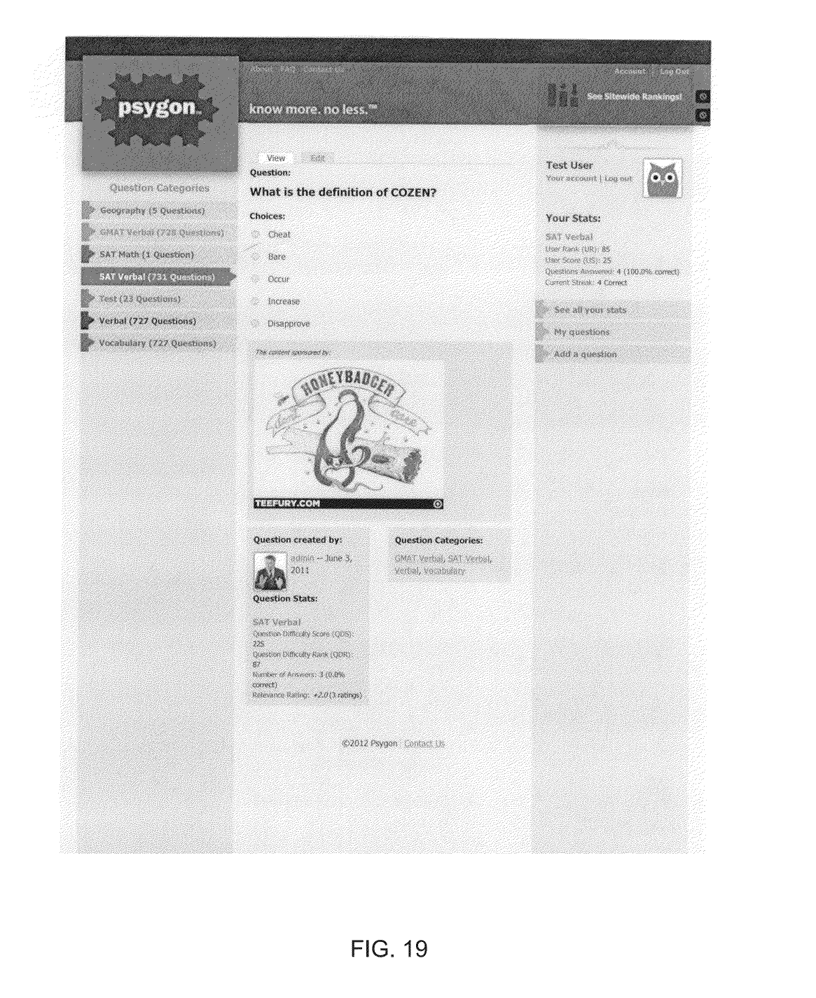

FIG. 19 illustrates a screen display of another example in which a question is presented to a user in accordance with embodiments of the present disclosure. Referring to FIG. 19, the screen display also provides information for identifying the question's creator, difficulty score, difficulty rank, number of answers, and relevance rating.

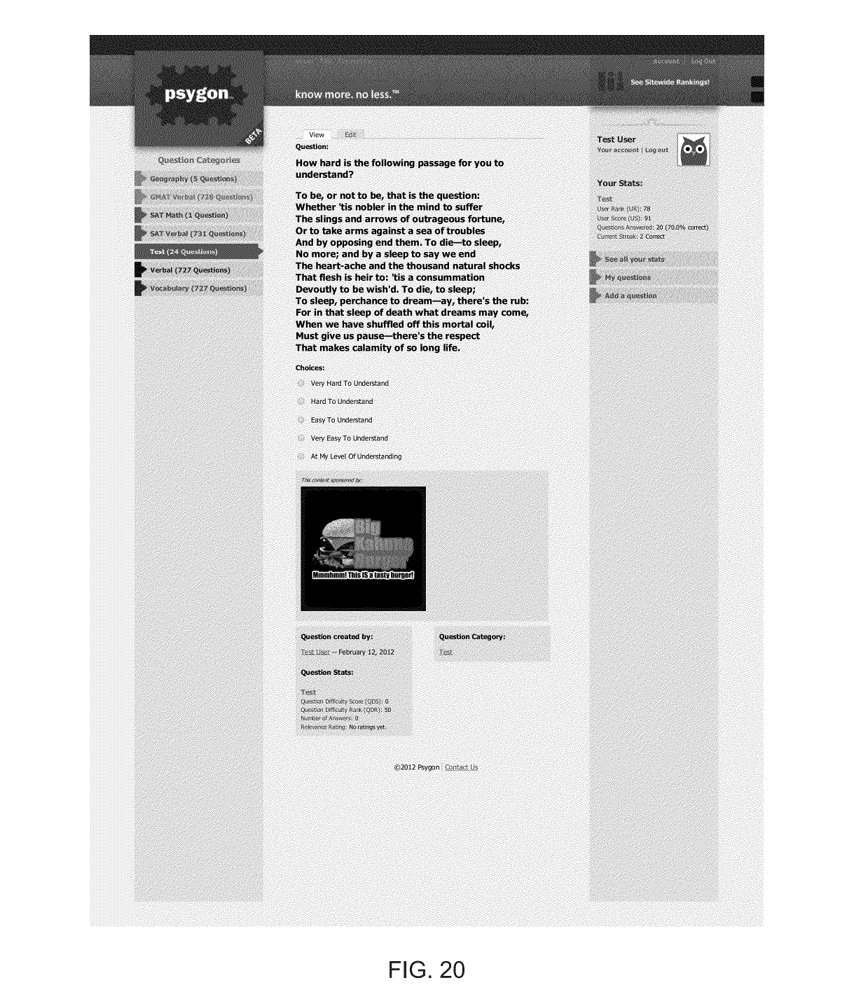

FIG. 20 illustrates a screen display of an example in which a reading passage is presented to a user in accordance with embodiments of the present disclosure. Referring to FIG. 20, the text of the reading passage is presented to the user along with choices for selection of a difficulty level of the reading passage.

The various techniques described herein may be implemented with hardware or software or, where appropriate, with a combination of both. Thus, the methods and apparatus of the disclosed embodiments, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the presently disclosed subject matter. In the case of program code execution on programmable computers, the computer will generally include a processor, a storage medium readable by the processor (including volatile and non-volatile memory and/or storage elements), at least one input device and at least one output device. One or more programs may be implemented in a high level procedural or object oriented programming language to communicate with a computer system. However, the program(s) can be implemented in assembly or machine language, if desired. In any case, the language may be a compiled or interpreted language, and combined with hardware implementations.

The described methods and apparatus may also be embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, a video recorder or the like, the machine becomes an apparatus for practicing the presently disclosed subject matter. When implemented on a general-purpose processor, the program code combines with the processor to provide a unique apparatus that operates to perform the processing of the presently disclosed subject matter.

Features from one embodiment or aspect may be combined with features from any other embodiment or aspect in any appropriate combination. For example, any individual or collective features of method aspects or embodiments may be applied to apparatus, system, product, or component aspects of embodiments and vice versa.

While the embodiments have been described in connection with the various embodiments of the various figures, it is to be understood that other similar embodiments may be used or modifications and additions may be made to the described embodiment for performing the same function without deviating therefrom. Therefore, the disclosed embodiments should not be limited to any single embodiment, but rather should be construed in breadth and scope in accordance with the appended claims.

What is claimed:

1. A method for providing informational content to a user, the method comprising:
using a processor for:
receiving user response to presentation of informational content associated with a first difficulty level;
associating a second difficulty level with the informational content based at least partly on the user response and the first difficulty level; and
providing the informational content to a user based at least partly on the second difficulty level.

2. The method of claim 1, wherein receiving user response comprises receiving a plurality of user responses to presentation of the informational content from a plurality of different users.

3. The method of claim 2, wherein the user responses are received over a period of time, and
wherein the method further comprises associating the informational content with a plurality of different difficulty levels over the period of time and based at least partly on the user responses.

4. The method of claim 1, wherein the user is a first user,
wherein receiving user response comprises receiving input from a second user,
wherein the method further comprises:
receiving from the second user an indication of relevance of the informational content; and
associating a relevance level with the informational content based on the indication of relevance.

5. The method of claim 4, wherein providing the informational content comprises providing the informational content to the first user based at least partly on the relevance level.

6. The method of claim 1, wherein the user is associated with a proficiency level, and
wherein providing the informational content comprises providing the informational content to the user based at least partly on the proficiency level associated with the user.

7. The method of claim 1, wherein the user is a first user,
wherein the user response is received from a second user associated with a proficiency level, and
wherein associating the second difficulty level comprises associating the second difficulty level with the informational content based at least partly on the proficiency level associated with the second user.

8. The method of claim 7, wherein the proficiency level is a first proficiency level, and
wherein the method further comprises associating a second proficiency level with the second user based on the user response, the first difficulty level, and the first proficiency level.

9. A system for providing informational content to a user, the system comprising:
a processor configured to:
receive user response to presentation of informational content associated with a first difficulty level;
associate a second difficulty level with the informational content based at least partly on the user response and the first difficulty level; and
provide the informational content to a user based at least partly on the second difficulty level.

10. The system of claim 9, wherein the processor is configured to receive a plurality of user responses to presentation of the informational content from a plurality of different users.

11. The system of claim 10, wherein the user responses are received over a period of time, and wherein the processor is configured to associate the informational content with a plurality of different difficulty levels over the period of time and based on the user responses.

12. The system of claim 9, wherein the user is a first user,
wherein the processor is configured to:
receive input from a second user;
receive from the second user an indication of relevance of the informational content; and
associate a relevance level with the informational content based at least partly on the indication of relevance.

13. The system of claim 12, wherein the processor is configured to provide the informational content to the first user based at least partly on the relevance level.

14. The system of claim 9, wherein the user is associated with a proficiency level, and
wherein the processor is configured to provide the informational content to the user based at least partly on the proficiency level associated with the user.

15. The system of claim 9, wherein the user is a first user,
wherein the user response is received from a second user associated with a proficiency level, and
wherein the processor is configured to associate the second difficulty level with the informational content based at least partly on the proficiency level associated with the second user.

16. A non-transitory computer-readable storage medium having stored thereon computer executable instructions for performing the following steps:
receiving user response to presentation of informational content associated with a first difficulty level;
associating a second difficulty level with the informational content based at least partly on the user response and the first difficulty level; and
providing the informational content to a user based at least partly on the second difficulty level.

17. The non-transitory computer-readable storage medium of claim 16, wherein receiving user response comprises receiving a plurality of user responses to presentation of the informational content from a plurality of different users.

18. The non-transitory computer-readable storage medium of claim 17, wherein the user responses are received over a period of time, and
wherein the steps further comprises associating the informational content with a plurality of different difficulty levels over the period of time and based at least partly on the user responses.

19. The non-transitory computer-readable storage medium of claim 16, wherein the user is a first user,
wherein receiving user response comprises receiving input from a second user,
wherein the steps further comprise:
receiving from the second user an indication of relevance of the informational content; and
associating a relevance level with the informational content based at least partly on the indication of relevance.

20. The non-transitory computer-readable storage medium of claim 19, wherein providing the informational content comprises providing the informational content to the first user based at least partly on the relevance level.
